(19) United States
(12) Patent Application Publication
(10) Pub. No.: US 2024/0224355 A1
(43) Pub. Date: Jul. 4, 2024

(54) METHOD FOR DETERMINING KEY OBTAINING MANNER, COMMUNICATION METHOD, AND COMMUNICATION APPARATUS

(71) Applicant: HUAWEI TECHNOLOGIES CO., LTD., Shenzhen (CN)

(72) Inventors: Ao LEI, Beijing (CN); He LI, Shanghai (CN); Yizhuang WU, Beijing (CN)

(21) Appl. No.: 18/606,038

(22) Filed: Mar. 15, 2024

Related U.S. Application Data
(63) Continuation of application No. PCT/CN2022/117689, filed on Sep. 8, 2022.

(30) Foreign Application Priority Data
Sep. 16, 2021 (CN) 202111089119.7

(51) Int. Cl. H04W 76/14; H04W 88/04; H04W 92/18

(52) U.S. Cl. CPC H04W 76/14; H04W 88/04; H04W 92/18

(57) ABSTRACT

A method for determining a key obtaining manner, a communication method, and a communication apparatus. In response to a preset condition being met, a first terminal device sends a first message to a second terminal device, where the first message includes first indication information. The first indication information indicates a first PC5 key in a control plane manner is to be obtained, and the first PC5 key is a key used for a PC5 link between the first terminal device and the second terminal device. The first terminal device receives, from the second terminal device, a response message of the first message, where the response message indicates whether the second terminal device is able to obtain the first PC5 key.

### CROSS-REFERENCE TO RELATED APPLICATIONS

This application is a continuation of International Application No. PCT/CN2022/117689, filed on Sep. 8, 2022, which claims priority to Chinese Patent Application No. 202111089119.7, filed on Sep. 16, 2021. The disclosures of the aforementioned applications are hereby incorporated by reference in their entireties.

### BACKGROUND

In response to user equipment (user equipment, UE) being located outside network coverage or a communication signal between the user equipment and a radio access network (radio access network, RAN) device being poor, remote UE (remote UE) uses relay UE (relay UE) to assist in communication. In other words, the remote UE obtains a service through communication between the remote UE and the relay UE and communication between the relay UE and a mobile network. A communication manner from the remote UE to the relay UE to the network is referred to as UE-to-network relay (UE-to-network relay) communication.

Before the relay UE serves the remote UE, the remote UE and the relay UE establish a PC5 unicast link. In a process of establishing the PC5 unicast link, the remote UE and the relay UE obtain, from a network side in a control plane manner or a user plane manner, a PC5 key used for the PC5 unicast link. However, currently, a condition based on which the remote UE and the relay UE select whether to obtain the PC5 key in the control plane manner or the user plane manner is not defined.

### SUMMARY

Embodiments described herein provide a method for determining a key obtaining manner, to resolve a problem of how to determine a manner of obtaining a PC5 key.

According to a first aspect, a method for determining a key obtaining manner is provided. The method includes: In response to a preset condition being met, a first terminal device sends a first message to a second terminal device, where the first message includes first indication information, the first indication information indicates to obtain a first PC5 key in a control plane manner, and the first PC5 key is a key used for a PC5 link between the first terminal device and the second terminal device: and the first terminal device receives, from the second terminal device, a response message of the first message, where the response message indicates whether the second terminal device obtains the first PC5 key, where the preset condition includes one or more of the following: a first public land mobile network identifier (public land mobile network identifier, PLMN ID) of a home network of the first terminal device is inconsistent with a second PLMN ID of a home network of the second terminal device, a first relay service code (relay service code, RSC) used by the first terminal device in a proximity direct discovery procedure corresponds to a layer-2 terminal device-to-network relay communication service, a second RSC used by the second terminal device in a proximity direct discovery procedure corresponds to the layer-2 terminal device-to-network relay communication service, key information that is obtained by the first terminal device from a key management function network element and that is for determining the first PC5 key expires, and the first terminal device has not obtained the key information.

Based on the foregoing technical solution, the first terminal device determines, based on whether at least one of the preset conditions is met, whether to obtain the first PC5 key in the control plane manner, so that the first terminal device and the second terminal device obtains the first PC5 key in different manners in different scenarios, to obtain the PC5 key in a manner with lower signaling overheads and fewer wasted resources, to improve efficiency and a success rate of establishing the PC5 link.

For example, in response to the first terminal device and the second terminal device being terminal devices of different public land mobile networks (public land mobile networks, PLMNs), because a remote terminal device in the first terminal device and the second terminal device cannot access an internal network element in another PLMN by using a user plane, in response to the first PLMN ID being inconsistent with the second PLMN ID, the first terminal device determines to obtain the first PC5 key in the control plane manner, and sends the first indication information to the second terminal device, to ensure that the first terminal device and the second terminal device successfully obtain the first PC5 key and successfully establish the PC5 link.

For another example, in a layer-2 terminal device-to-network relay communication service scenario, a relay terminal device is not responsible for establishing a protocol data unit (protocol data unit, PDU) session for a remote terminal device. In response to the first PC5 key being obtained in a user plane manner, processing burden and processing logic of the relay terminal device are additionally increased. Therefore, in response to the first RSC or the second RSC corresponding to the layer-2 UE-to-network relay communication service, the first terminal device determines to obtain the first PC5 key in the control plane manner, and sends the first indication information to the second terminal device, so that the increase of processing logic and processing burden of the relay terminal device in the first terminal device and the second terminal device is avoided.

For another example, in the user plane manner, the remote terminal device obtains the key information from the key management network element in advance, and the key information distributed by the key management network element has a corresponding validity period. To be specific, after the key information expires, the remote terminal device cannot obtain the PC5 key, or the remote terminal device obtains the key information from the key management network element again. In response to the remote terminal device not being in network coverage, the remote terminal device cannot obtain the key information from the key management network element. Therefore, in response to the key information obtained by the first terminal device from the key management network element expiring, or the first terminal device not obtaining the key information, the first terminal device determines to obtain the first PC5 key in the control plane manner, and sends the first indication information to the second terminal device. This ensures that the first terminal device and the second terminal device successfully obtain the first PC5 key and successfully establish the PC5 link.

In at least one embodiment, the first terminal device is a remote terminal device, the second terminal device is a relay terminal device, and the preset condition includes one or more of the following: the first PLMN ID is inconsistent with the second PLMN ID, the first RSC corresponds to the layer-2 terminal device-to-network relay communication service, the second RSC corresponds to the layer-2 terminal device-to-network relay communication service, the key information obtained by the first terminal device from the key management function network element expires, and the first terminal device has not obtained the key information.

In at least one embodiment, the first terminal device is a relay terminal device, the second terminal device is a remote terminal device, and the preset condition includes one or more of the following: the first PLMN ID is inconsistent with the second PLMN ID, the first RSC corresponds to the layer-2 terminal device-to-network relay communication service, and the second RSC corresponds to the layer-2 terminal device-to-network relay communication service.

With reference to the first aspect, in at least one embodiment of the first aspect, the method further includes: The first terminal device receives a third message from the second terminal device, where the third message includes the second PLMN ID and the second RSC.

For example, the key management function network element corresponds to the first PLMN ID or the second PLMN ID, and that the first terminal device has not obtained the key information includes: The first terminal device has not obtained the key information from the key management function network element. In other words, the preset condition includes one or more of the following: The first terminal device has not obtained the key information from the key management network element corresponding to the first PLMN ID or the second PLMN ID, or the key information obtained by the first terminal device from the first PLMN ID or the second PLMN ID expires.

In response to the first terminal device determining that the first PC5 key is obtained in the control plane manner and the user plane manner, the first terminal device sends, in response to the preset condition being met, the first message including the first indication information to the second terminal device.

For example, the method further includes: The first terminal device receives first information, where the first information indicates that the first terminal device obtains a PC5 key in the control plane manner and the user plane manner. Correspondingly, the first terminal device determines, based on the first information, that the first PC5 key is obtained in the control plane manner and the user plane manner.

For another example, the method further includes: The first terminal device receives first information, where the first information includes a mapping relationship between the first PLMN ID and second indication information or a mapping relationship between the second PLMN ID and second indication information, and the second indication information indicates to obtain a PC5 key in the control plane manner and the user plane manner. Correspondingly, the first terminal device determines, based on the second indication information, that the first PC5 key is obtained in the control plane manner and the user plane manner.

In addition to the mapping relationship between the first PLMN ID and the second indication information or the mapping relationship between the second PLMN ID and the second indication information, the first information further includes a mapping relationship between a PLMN ID and indication information that indicates a manner of obtaining the PC5 key and that is in all PLMNs that have a roaming agreement with a carrier of the home network of the first terminal device.

Optionally, in response to the second indication information corresponding to the second PLMN ID, the first PC5 key is generated by a network element in the second PLMN: or in response to the second indication information corresponding to the first PLMN ID, the first PC5 key is generated by a network element in the first PLMN.

For still another example, the method further includes: The first terminal device receives first information, where the first information includes a mapping relationship between identifier information of a relay service corresponding to the PC5 link and second indication information, and the second indication information indicates to obtain a PC5 key in the control plane manner and the user plane manner. Correspondingly, the first terminal device determines, based on the second indication information, that the first PC5 key is obtained in the control plane manner and the user plane manner. The identifier information of the relay service is RSC information.

In addition to the mapping relationship between the identifier information of the relay service corresponding to the PC5 link and the second indication information, the first information further includes a mapping relationship between relay service identifier information of all relay services that is used by the first terminal device and corresponding indication information that indicates a manner of obtaining a PC5 key. The identifier information of the relay service is RSC information.

With reference to the first aspect, in at least one embodiment of the first aspect, the method further includes: The first terminal device determines the first indication information based on the first information.

According to a second aspect, a method for determining a key obtaining manner is provided. The method includes: A second terminal device receives a first message from a first terminal device, where the first message includes first indication information, the first indication information indicates to obtain a first PC5 key in a control plane manner, and the first PC5 key is a key used for a PC5 link between the first terminal device and the second terminal device: and the second terminal device sends a response message of the first message sent by the first terminal device, where the response message indicates whether the second terminal device obtains the first PC5 key.

Based on the foregoing technical solution, in response to the first message sent by the first terminal device to the second terminal device including the first indication information, the second terminal device sends the response message of the first message to the first terminal device, so that the first terminal device determines, based on the response message, whether the second terminal device obtains the first PC5 key, to ensure successful establishment of the PC5 link or reduce signaling. For example, in response to the response message indicating that the second terminal device obtains the first PC5 key, the first terminal device continues to perform a PC5 link establishment procedure with the second terminal device, to ensure that the PC5 link is successfully established. For another example, in response to the response message indicating that the second terminal device cannot obtain the first PC5 key, the first terminal device terminates the PC5 link establishment procedure with the second terminal device, to reduce signaling.

In response to the second terminal device determining that the first PC5 key is obtained in the control plane manner, the response message indicates that the second terminal device obtains the first PC5 key: or in response to the second terminal device determining that the first PC5 key cannot be obtained in the control plane manner, the response message indicates that the second terminal device cannot obtain the first PC5 key.

For example, the method further includes: The second terminal device receives second information, where the second information indicates that the second terminal device obtains a PC5 key in the control plane manner and/or a user plane manner. Correspondingly, the second terminal device determines, based on the second information, that the first PC5 key is obtained in the control plane manner and/or the user plane manner.

For another example, the method further includes: The second terminal device receives second information, where the second information includes a mapping relationship between a first PLMN ID of a home network of the first terminal device and third indication information or a mapping relationship between a second PLMN ID of a home network of the second terminal device and third indication information, and the third indication information indicates to obtain a PC5 key in the control plane manner and/or a user plane manner. Correspondingly, the second terminal device determines, based on the third indication information, that the first PC5 key is obtained in the control plane manner and/or the user plane manner.

In addition to the mapping relationship between the first PLMN ID and the third indication information or the mapping relationship between the second PLMN ID and the third indication information, the second information further includes a mapping relationship between a PLMN ID and indication information that indicates a manner of obtaining the PC5 key and that is in all PLMNs that have a roaming agreement with a carrier of the home network of the second terminal device.

For still another example, the method further includes: The second terminal device receives second information, where the second information includes a mapping relationship between identifier information of a relay service corresponding to the PC5 link and third indication information, and the third indication information indicates to obtain a PC5 key in the control plane manner and/or a user plane manner. Correspondingly, the second terminal device determines, based on the third indication information, that the first PC5 key is obtained in the control plane manner and/or the user plane manner.

In addition to the mapping relationship between the identifier information of the relay service corresponding to the PC5 link and the third indication information, the first information further includes a mapping relationship between relay service identifier information of all relay services that is used by the second terminal device and corresponding indication information that indicates a manner of obtaining a PC5 key. The identifier information of the relay service is RSC information.

According to a third aspect, a communication method is provided. The method includes: A policy control function network element receives, from an access and mobility management function network element, a request message for requesting a proximity service (proximity-based service, ProSe) parameter of a first terminal device: and the policy control function network element sends the ProSe parameter to the first terminal device, where the ProSe parameter includes first information, the first information is for determining a manner of obtaining a first PC5 key, the first PC5 key is a key used for a PC5 link between the first terminal device and a second terminal device, and the manner of obtaining the first PC5 key includes a control plane manner and/or a user plane manner.

Based on the foregoing technical solution, the policy control function network element sends the first information to the first terminal device in the ProSe parameter, so that the first terminal device determines, based on the first information, the manner of obtaining the first PC5 key. This helps the first terminal device and the second terminal device successfully establish the PC5 link.

For example, the first information indicates to obtain a PC5 key in the control plane manner and/or the user plane manner.

For another example, the first information includes a mapping relationship between a first PLMN ID of a home network of the first terminal device and second indication information or a mapping relationship between a second PLMN ID of a home network of the second terminal device and second indication information, and the second indication information indicates to obtain a PC5 key in the control plane manner and the user plane manner.

Optionally, in response to the second indication information corresponding to the second PLMN ID, the first PC5 key is generated by a network element in the second PLMN: or in response to the second indication information corresponding to the first PLMN ID, the first PC5 key is generated by a network element in the first PLMN.

For still another example, the first information includes a mapping relationship between identifier information of a relay service corresponding to the PC5 link and second indication information, and the second indication information indicates to obtain a PC5 key in the control plane manner and the user plane manner. The identifier information of the relay service is RSC information.

A manner in which the policy control function network element obtains the first information is not limited in at least one embodiment.

For example, the policy control function network element obtains the first information from the access and mobility management function network element. In other words, the first request message includes the first information.

For another example, the method further includes: The policy control function network element obtains the first information from local configuration.

For still another example, the policy control function network element obtains the first information from an application function network element. In other words, the method further includes: The policy control function network element receives the first information from an application function network element.

For yet another example, the first network element obtains the first information from a first network element. In other words, the method further includes: The policy control function network element sends, to a first network element, a request message for requesting the first information: and the policy control function network element receives the first information from the first network element. The first network element is a unified data management network element or a direct communication discovery name management network element.

According to a fourth aspect, a communication method is provided. The method includes: An access and mobility management function network element receives subscription data and first information of a first terminal device from a unified data management network element, where the first information is used by the first terminal device to determine a manner of obtaining a first PC5 key, the first PC5 key is a key used for a PC5 link between the first terminal device and a second terminal device, and the manner of obtaining the first PC5 key includes a control plane manner and/or a user plane manner: and the access and mobility management function network element sends, to a policy control function network element, a request message for requesting a ProSe parameter of the first terminal device, where the first request message includes the first information.

Based on the foregoing technical solution, the access and mobility management function network element sends the first information to the policy control function network element, so that the policy control function network element sends the first information to the first terminal device in the ProSe parameter, and further, the first terminal device determines, based on the first information, the manner of obtaining the first PC5 key. This helps the first terminal device and the second terminal device successfully establish the PC5 link.

For example, the first information indicates to obtain a PC5 key in the control plane manner and/or the user plane manner.

For another example, the first information includes a mapping relationship between a first PLMN ID of a home network of the first terminal device and second indication information or a mapping relationship between a second PLMN ID of a home network of the second terminal device and second indication information, and the second indication information indicates to obtain a PC5 key in the control plane manner and the user plane manner.

Optionally, in response to the second indication information corresponding to the second PLMN ID, the first PC5 key is generated by a network element in the second PLMN: or in response to the second indication information corresponding to the first PLMN ID, the first PC5 key is generated by a network element in the first PLMN.

For still another example, the first information includes a mapping relationship between identifier information of a relay service corresponding to the PC5 link and second indication information, and the second indication information indicates to obtain a PC5 key in the control plane manner and the user plane manner. The identifier information of the relay service is RSC information.

According to a fifth aspect, a communication apparatus is provided, where the communication apparatus includes a transceiver unit. The transceiver unit is configured to: in response to a preset condition being met, send a first message to a second terminal device, where the first message includes first indication information, the first indication information indicates to obtain a first PC5 key in a control plane manner, and the first PC5 key is a key used for a PC5 link between a first terminal device and the second terminal device. The transceiver unit is further configured to: receive, from the second terminal device, a response message of the first message, where the response message indicates whether the second terminal device obtains the first PC5 key. The preset condition includes one or more of the following: a first PLMN ID of a home network of the first terminal device is inconsistent with a second PLMN ID of a home network of the second terminal device, a first RSC used by the first terminal device in a proximity direct discovery procedure corresponds to a layer-2 terminal device-to-network relay communication service, a second RSC used by the second terminal device in a proximity direct discovery procedure corresponds to the layer-2 terminal device-to-network relay communication service, key information that is obtained by the first terminal device from a key management function network element and that is for determining the first PC5 key expires, and the first terminal device has not obtained the key information.

With reference to the fifth aspect, in some implementations of the fifth aspect, the first terminal device is a remote terminal device, the second terminal device is a relay terminal device, and the preset condition includes one or more of the following: the first PLMN ID is inconsistent with the second PLMN ID, the first RSC corresponds to the layer-2 terminal device-to-network relay communication service, the second RSC corresponds to the layer-2 terminal device-to-network relay communication service, the key information obtained by the first terminal device from the key management function network element expires, and the first terminal device has not obtained the key information.

With reference to the fifth aspect, in some implementations of the fifth aspect, the first terminal device is a relay terminal device, the second terminal device is a remote terminal device, and the preset condition includes one or more of the following: the first PLMN ID is inconsistent with the second PLMN ID, the first RSC corresponds to the layer-2 terminal device-to-network relay communication service, and the second RSC corresponds to the layer-2 terminal device-to-network relay communication service.

With reference to the fifth aspect, in some implementations of the fifth aspect, the transceiver unit is further configured to receive a third message from the second terminal device, where the third message includes the second PLMN ID and the second RSC.

With reference to the fifth aspect, in some implementations of the fifth aspect, the key management function network element corresponds to the first PLMN ID or the second PLMN ID, and that the first terminal device has not obtained the key information includes: The first terminal device has not obtained the key information from the key management function network element.

With reference to the fifth aspect, in some implementations of the fifth aspect, the transceiver unit is further configured to receive first information, where the first information indicates that the first terminal device obtains a PC5 key in the control plane manner and a user plane manner.

With reference to the fifth aspect, in some implementations of the fifth aspect, the transceiver unit is further configured to receive first information, where the first information includes a mapping relationship between the first PLMN ID and second indication information or a mapping relationship between the second PLMN ID and second indication information, and the second indication information indicates to obtain a PC5 key in the control plane manner and a user plane manner.

With reference to the fifth aspect, in some implementations of the fifth aspect, the transceiver unit is further configured to receive first information, where the first information includes a mapping relationship between identifier information of a relay service corresponding to the PC5 link and second indication information, and the second indication information indicates to obtain a PC5 key in the control plane manner and a user plane manner.

With reference to the fifth aspect, in some implementations of the fifth aspect, the communication apparatus further includes a processing unit, and the processing unit is configured to determine the first indication information based on the first information.

According to a sixth aspect, a communication apparatus is provided, where the communication apparatus includes a transceiver unit. The transceiver unit is configured to receive a first message from a first terminal device, where the first message includes first indication information, the first indication information indicates to obtain a first PC5 key in a control plane manner, and the first PC5 key is a key used for a PC5 link between the first terminal device and a second terminal device. The transceiver unit is further configured to send a response message of the first message to the first terminal device, where the response message indicates whether the second terminal device obtains the first PC5 key.

With reference to the sixth aspect, in some implementations of the sixth aspect, in response to the second terminal device obtaining the first PC5 key in the control plane manner, the response message indicates that the second terminal device obtains the first PC5 key: or in response to the second terminal device not obtaining the first PC5 key in the control plane manner, the response message indicates that the second terminal device cannot obtain the first PC5 key.

With reference to the sixth aspect, in some implementations of the sixth aspect, the transceiver unit is further configured to receive second information, where the second information indicates that the second terminal device obtains a PC5 key in the control plane manner and/or a user plane manner.

With reference to the sixth aspect, in some implementations of the sixth aspect, the transceiver unit is further configured to receive second information, where the second information includes a mapping relationship between a first PLMN ID of a home network of the first terminal device and third indication information or a mapping relationship between a second PLMN ID of a home network of the second terminal device and third indication information, and the third indication information indicates to obtain a PC5 key in the control plane manner and/or a user plane manner.

With reference to the sixth aspect, in some implementations of the sixth aspect, the transceiver unit is further configured to receive second information, where the second information includes a mapping relationship between identifier information of a relay service corresponding to the PC5 link and third indication information, and the third indication information indicates to obtain a PC5 key in the control plane manner and/or a user plane manner.

According to a seventh aspect, a communication apparatus is provided, where the communication apparatus includes a transceiver unit. The transceiver unit is configured to: receive, from an access and mobility management function network element, a request message for requesting a ProSe parameter of a first terminal device. The transceiver unit is further configured to send the ProSe parameter to the first terminal device, where the ProSe parameter includes first information, the first information is for determining a manner of obtaining a first PC5 key, the first PC5 key is a key used for a PC5 link between the first terminal device and a second terminal device, and the manner of obtaining the first PC5 key includes a control plane manner and/or a user plane manner.

For example, the first information indicates to obtain a PC5 key in the control plane manner and/or the user plane manner.

For another example, the first information includes a mapping relationship between a first PLMN ID of a home network of the first terminal device and second indication information or a mapping relationship between a second PLMN ID of a home network of the second terminal device and second indication information, and the second indication information indicates to obtain a PC5 key in the control plane manner and the user plane manner.

Optionally, in response to the second indication information corresponding to the second PLMN ID, the first PC5 key is generated by a network element in the second PLMN: or in response to the second indication information corresponding to the first PLMN ID, the first PC5 key is generated by a network element in the first PLMN.

For still another example, the first information includes a mapping relationship between identifier information of a relay service corresponding to the PC5 link and second indication information, and the second indication information indicates to obtain a PC5 key in the control plane manner and the user plane manner.

With reference to the seventh aspect, in at least one embodiment of the seventh aspect, the first request message includes the first information.

With reference to the seventh aspect, in at least one embodiment of the seventh aspect, the transceiver unit is further configured to obtain the first information from local configuration.

With reference to the seventh aspect, in at least one embodiment of the seventh aspect, the transceiver unit is further configured to receive the first information from an application function network element.

With reference to the seventh aspect, in at least one embodiment of the seventh aspect, the transceiver unit is further configured to: send, to a first network element, a request message for requesting the first information: and the transceiver unit is further configured to receive the first information from the first network element. The first network element is a unified data management network element or a direct communication discovery name management network element.

According to an eighth aspect, a communication apparatus is provided, where the communication apparatus includes a transceiver unit. The transceiver unit is configured to receive subscription data and first information of a first terminal device from a unified data management network element, where the first information is used by the first terminal device to determine a manner of obtaining a first PC5 key, the first PC5 key is a key used for a PC5 link between the first terminal device and a second terminal device, and the manner of obtaining the first PC5 key includes a control plane manner and/or a user plane manner. The transceiver unit is further configured to: send, to a policy control function network element, a request message for requesting a ProSe parameter of the first terminal device, where the first request message includes the first information.

For example, the first information indicates to obtain a PC5 key in the control plane manner and/or the user plane manner.

For another example, the first information includes a mapping relationship between a first PLMN ID of a home network of the first terminal device and second indication information or a mapping relationship between a second PLMN ID of a home network of the second terminal device and second indication information, and the second indication information indicates to obtain a PC5 key in the control plane manner and the user plane manner.

Optionally, in response to the second indication information corresponding to the second PLMN ID, the first PC5 key is generated by a network element in the second PLMN: or in response to the second indication information corresponding to the first PLMN ID, the first PC5 key is generated by a network element in the first PLMN.

For still another example, the first information includes a mapping relationship between identifier information of a relay service corresponding to the PC5 link and second indication information, and the second indication information indicates to obtain a PC5 key in the control plane manner and the user plane manner.

According to a ninth aspect, at least one embodiment provides a communication device including a processor. The processor is coupled to a memory, and is configured to execute instructions in the memory, to implement the method according to any one of the first aspect and implementations of the first aspect. The communication device further includes a memory. The communication device further includes a communication interface, and the processor is coupled to the communication interface.

In an implementation, the communication device is a first terminal device. In response to the communication device being the first terminal device, the communication interface is a transceiver or an input/output interface.

In another implementation, the communication device is a chip or a chip system configured in a first terminal device. In response to the communication device being the chip or the chip system configured in the first terminal device, the communication interface is an input/output interface.

The transceiver is a transceiver circuit. The input/output interface is an input/output circuit.

According to a tenth aspect, at least one embodiment provides a communication device including a processor. The processor is coupled to a memory, and is configured to execute instructions in the memory, to implement the method according to any one of the second aspect and implementations of the second aspect. The communication device further includes a memory. The communication device further includes a communication interface, and the processor is coupled to the communication interface.

In an implementation, the communication device is a second terminal device. In response to the communication device being the second terminal device, the communication interface is a transceiver or an input/output interface.

In another implementation, the communication device is a chip or a chip system configured in a second terminal device. In response to the communication device being the chip or the chip system configured in the second terminal device, the communication interface is an input/output interface.

The transceiver is a transceiver circuit. The input/output interface is an input/output circuit.

According to an eleventh aspect, at least one embodiment provides a communication device including a processor. The processor is coupled to a memory, and is configured to execute instructions in the memory, to implement the method according to any one of the third aspect and implementations of the third aspect. The communication device further includes a memory. The communication device further includes a communication interface, and the processor is coupled to the communication interface.

In an implementation, the communication device is a policy control function network element. In response to the communication device being the policy control function network element, the communication interface is a transceiver or an input/output interface.

In another implementation, the communication device is a chip or a chip system configured in a policy control function network element. In response to the communication device being the chip or the chip system configured in the policy control function network element, the communication interface is an input/output interface.

The transceiver is a transceiver circuit. The input/output interface is an input/output circuit.

According to a twelfth aspect, at least one embodiment provides a communication device including a processor. The processor is coupled to a memory, and is configured to execute instructions in the memory, to implement the method according to any one of the fourth aspect and implementations of the fourth aspect. The communication device further includes a memory. The communication device further includes a communication interface, and the processor is coupled to the communication interface.

In an implementation, the communication device is an access and mobility management function network element. In response to the communication device being the access and mobility management function network element, the communication interface is a transceiver or an input/output interface.

In another implementation, the communication device is a chip or a chip system configured in the access and mobility management function network element. In response to the communication device being the chip or the chip system configured in the access and mobility management function network element, the communication interface is an input/output interface.

The transceiver is a transceiver circuit. The input/output interface is an input/output circuit.

According to a thirteenth aspect, at least one embodiment provides a processor, including an input circuit, an output circuit, and a processing circuit. The processing circuit is configured to: receive a signal through the input circuit, and transmit a signal through the output circuit, so that the processor performs the methods in the foregoing aspects.

During specific implementation, the processor is a chip, the input circuit is an input pin, the output circuit is an output pin, and the processing circuit is a transistor, a gate circuit, a trigger, various logic circuits, or the like. An input signal received by the input circuit is, for example, but not limited to, received and input by a receiver, and a signal output by the output circuit is, for example, but not limited to, output to a transmitter and transmitted by the transmitter. The input circuit and the output circuit is a same circuit, and the circuit is used as the input circuit and the output circuit at different moments. Specific implementations of the processor and the various circuits are not limited in at least one embodiment.

According to a fourteenth aspect, at least one embodiment provides a processing apparatus, including a communication interface and a processor. The communication interface is coupled to the processor. The communication interface is configured to input and/or output information. The information includes at least one of instructions or data. The processor is configured to execute a computer program, so that the processing apparatus performs the methods in the foregoing aspects.

According to a fifteenth aspect, at least one embodiment provides a processing apparatus, including a processor and a memory. The processor is configured to: read instructions stored in the memory, receive a signal by using a receiver, and transmit a signal by using a transmitter, so that the processing apparatus performs the methods in the foregoing aspects.

Optionally, there are one or more processors. In response to there being a memory, there are alternatively one or more memories.

Optionally, the memory and the processor are integrated together, or the memory and the processor are separately disposed.

During specific implementation, the memory is a non-transitory (non-transitory) memory such as a read-only memory (read-only memory, ROM). The memory and the processor are integrated on a same chip, or are separately disposed on different chips. A type of the memory and a manner of disposing the memory and the processor are not limited in at least one embodiment.

In a related information exchange process, for example, sending indication information is a process of outputting the indication information from the processor, and receiving the indication information is a process of inputting the received indication information to the processor. Specifically, the information output by the processor is output to the transmitter, and the input information received by the processor is from the receiver. The transmitter and the receiver are collectively referred to as a transceiver.

The apparatuses according to the fourteenth aspect and the fifteenth aspect each is a chip. The processor is implemented by hardware or software. In response to the processor is implemented by hardware, the processor is a logic circuit, an integrated circuit, or the like. In response to the processor being implemented by software, the processor is a general-purpose processor, and is implemented by reading software code stored in the memory. The memory is integrated in the processor, or is located outside the processor and exists independently.

According to a sixteenth aspect, at least one embodiment provides a computer program product. The computer program product includes a computer program (also referred to as code or instructions). In response to the computer program being run, a computer is enabled to perform the methods in the foregoing aspects.

According to a seventeenth aspect, at least one embodiment provides a computer-readable storage medium. The computer-readable storage medium stores a computer program (also referred to as code or instructions). In response to the computer program being run on a computer, the computer is enabled to perform the methods in the foregoing aspects.

According to an eighteenth aspect, at least one embodiment provides a communication system, including the foregoing first terminal device and second terminal device, or including the foregoing first terminal device and/or second terminal device, the policy control function network element, and the access and mobility management function network element.

### BRIEF DESCRIPTION OF DRAWINGS

FIG. 1 is a schematic diagram of a network architecture applicable to at least one embodiment:

FIG. 2 is a schematic flowchart of establishing a unicast connection between remote UE and relay UE:

FIG. 3 is a schematic flowchart of a method for determining a key obtaining manner according to at least one embodiment:

FIG. 4 is a schematic flowchart of a method for determining a key obtaining manner according to at least one embodiment:

FIG. 5 is a schematic flowchart of a method for determining a key obtaining manner according to at least one embodiment:

FIG. 6 is a schematic flowchart of a method for determining a key obtaining manner according to at least one embodiment:

FIG. 7 is a schematic flowchart of a method for determining a key obtaining manner according to at least one embodiment:

FIG. 8 is a schematic flowchart of a communication method according to at least one embodiment:

FIG. 9 is a schematic flowchart of a method for determining a key obtaining manner according to at least one embodiment:

FIG. 10 is a schematic flowchart of a method for determining a key obtaining manner according to at least one embodiment:

FIG. 11 is a schematic block diagram of a communication apparatus according to at least one embodiment:

FIG. 12 is a schematic block diagram of a communication device according to at least one embodiment: and

FIG. 13 is a schematic diagram of a chip system according to at least one embodiment.

### DESCRIPTION OF EMBODIMENTS

The following describes technical solutions in at least one embodiment with reference to the accompanying drawings.

The technical solutions provided in at least one embodiment is applied to various communication systems, for example, a long term evolution (long term evolution, LTE) system, a frequency division duplex (frequency division duplex, FDD) system, a time division duplex (time division duplex, TDD) system, a universal mobile telecommunications system (universal mobile telecommunications system, UMTS), a worldwide interoperability for microwave access (worldwide interoperability for microwave access, WiMAX) communication system, a 5G system or a new radio (new radio, NR) system, or a 6th generation (6th generation, 6G) system or a future communication system. A 5G mobile communication system in at least one embodiment includes a non-standalone (non-standalone, NSA) 5G mobile communication system or a standalone (standalone, SA) 5G mobile communication system. The communication system is alternatively a public land mobile network (public land mobile network, PLMN), a device-to-device (device-to-device, D2D) communication system, a machine to machine (machine to machine, M2M) communication system, an internet of things (Internet of Things, IOT) communication system, a vehicle-to-everything (vehicle-to-everything, V2X) communication system, an uncrewed aerial vehicle (uncrewed aerial vehicle, UAV) communication system, or another communication system.

The following describes the technical solutions in at least one embodiment with reference to the accompanying drawings in at least one embodiment. In the descriptions of at least one embodiment, “/” represents an “or” relationship between associated objects unless otherwise specified. For example, A/B represents A or B. The term “and/or” in at least one embodiment indicates only an association relationship for describing associated objects and indicates that three relationships exist. For example, A and/or B indicate the following three cases: Only A exists, both A and B exist, and only B exists, where A and B is singular or plural. In addition, in the descriptions of at least one embodiment, “a plurality of” means two or more than two unless otherwise specified. “At least one of the following items (pieces)” or a similar expression thereof means any combination of these items, including any combination of singular items (pieces) or plural items (pieces). For example, at least one item (piece) of a, b, or c indicates: a, b, c, a and b, a and c, b and c, or a, b, and c, where a, b, and c is singular or plural. In addition, to clearly describe the technical solutions in at least one embodiment, words such as “first” and “second” are used in at least one embodiment to distinguish between same items or similar items that have basically same functions or purposes. A person skilled in the art understands that the terms such as “first” and “second” do not limit a quantity or an execution sequence, and the terms such as “first” and “second” do not indicate a definite difference. In addition, in at least one embodiment, the word such as “example” or “for example” is used to represent giving an example, an illustration, or descriptions. Any embodiment or design scheme described as an “example” or with “for example” in at least one embodiment should not be explained as being more preferred or having more advantages than another embodiment or design scheme. Exactly, use of the word such as “example” or “for example” is intended to present a relative concept in a specific manner for ease of understanding.

In addition, the network architecture and the service scenario described in at least one embodiment are intended to describe the technical solutions in at least one embodiment more clearly, and do not constitute a limitation on the technical solutions provided in at least one embodiment. A person of ordinary skill in the art knows that: With the evolution of the network architecture and the emergence of new service scenarios, the technical solutions provided in at least one embodiment are also applicable to similar technical problems.

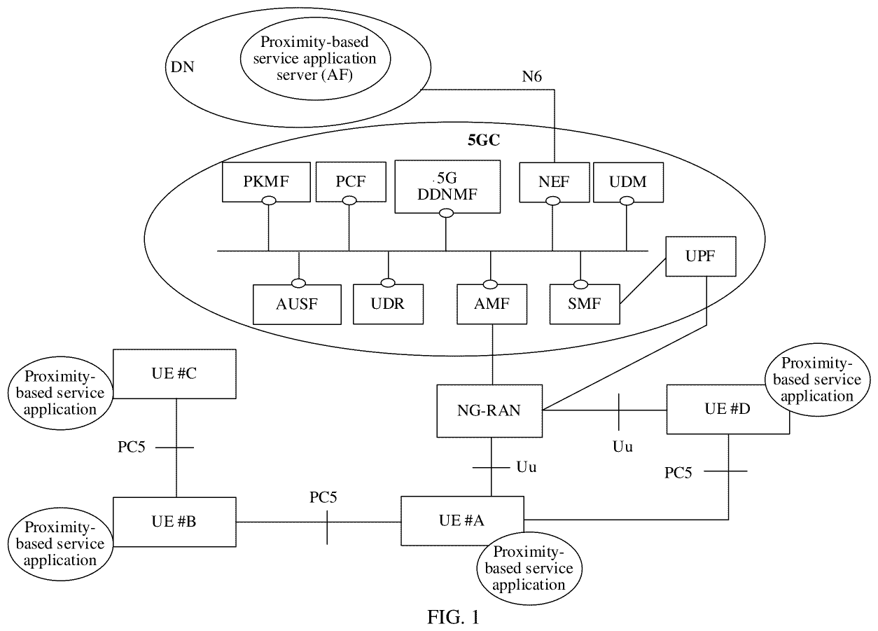

For ease of understanding at least one embodiment, an application scenario of at least one embodiment is first described in detail with reference to FIG. 1.

FIG. 1 is a schematic diagram of a network architecture applicable to a method according to at least one embodiment. As shown in the figure, the network architecture specifically includes the following network elements.

1. User equipment (user equipment, UE): The user equipment is referred to as a terminal device, a terminal, an access terminal, a subscriber unit, a subscriber station, a mobile station, a remote station, a remote terminal, a mobile device, a user terminal, a wireless communication device, a user agent, or a user apparatus. The terminal device is alternatively a cellular phone, a cordless phone, a session initiation protocol (session initiation protocol, SIP) phone, a wireless local loop (wireless local loop, WLL) station, a personal digital assistant (personal digital assistant, PDA), a handheld device having a wireless communication function, a computing device, another processing device connected to a wireless modem, a vehicle-mounted device, an uncrewed aerial vehicle, a wearable device, a terminal device in a 5G network, a terminal device in an evolved public land mobile network (public land mobile network, PLMN), or the like. This is not limited in at least one embodiment. The UE is connected to a next generation radio access network (next generation radio access network, NG-RAN) device through a Uu interface. For example, UE #A and UE #D shown in FIG. 1 are connected to an NG-RAN through a Uu interface. Two UEs having a proximity-based service application (proximity-based service application, ProSe application) function are also connected through a PC5 interface. For example, as shown in FIG. 1, UE #A and UE #B are connected through a PC5 interface, UE #B and UE #C are connected through a PC5 interface, and UE #A and UE #D are connected through a PC5 interface.

2. Access network (access network, AN): The access network provides a network access function for an authorized user in a specific area, and uses transmission tunnels with different quality based on user levels, service usage, and the like. Different access networks use different access technologies. Current access network technologies include a radio access network technology used in a third generation (3rd generation, 3G) system, a radio access network technology used in a 4G system, the NG-RAN technology (for example, a radio access technology used in a 5G system) shown in FIG. 1, and the like.

An access network that implements the network access function based on a wireless communication technology is referred to as a radio access network (radio access network, RAN). The radio access network manages radio resources, provides an access service for a terminal, and further completes forwarding of a control signal and user data between the terminal and a core network.

The radio access network device is, for example, a NodeB (NodeB), an evolved NodeB (evolved NodeB, eNB, or eNodeB), a next generation node base station (next generation Node Base station, gNB) in a 5G mobile communication system, a base station in a mobile communication system, or an access point (access point, AP) in a Wi-Fi wireless hotspot (Wi-Fi) system, or is a radio controller in a cloud radio access network (cloud radio access network, CRAN) scenario. Alternatively, the radio access network device is a relay station, an access point, a vehicle-mounted device, an uncrewed aerial vehicle, a wearable device, a network device in a 5G network, a network device in an evolved PLMN, or the like. A specific technology and a specific device form that are used by the radio access network device are not limited in at least one embodiment.

3. Access management network element: The access management network element is mainly used for mobility management and access management, is responsible for transferring a user policy between user equipment and a policy control function (policy control function, PCF) network element, and the like, and is configured to implement a function other than session management in functions of a mobility management entity (mobility management entity, MME), for example, a lawful interception function or an access authorization (or authentication) function.

In a 5G communication system, the access management network element is an access and mobility management function (access and mobility management function, AMF) network element. In a future communication system, the access management network element is still an AMF network element, or has another name. This is not limited in at least one embodiment.

4. Session management network element: The session management network element is mainly configured to: manage a session, allocate and manage an Internet Protocol (internet protocol, IP) address of user equipment, select an endpoint that manages a user plane function interface and a policy control and charging function interface, performs downlink data notification, and the like.

In the 5G communication system, the session management network element is a session management function (session management function, SMF) network element. In the future communication system, the session management network element is still an SMF network element, or has another name. This is not limited in at least one embodiment.

5. User plane network element: The user plane network element is configured to: perform functions such as packet routing and forwarding, quality of service (quality of service, QoS) processing of user plane data, user plane data forwarding, charging statistics based on a session/flow-level, and bandwidth limitation.

In the 5G communication system, the user plane network element is a user plane function (user plane function, UPF) network element. In the future communication system, the user plane network element is still a UPF network element, or has another name. This is not limited in at least one embodiment.

6. Data network element: The data network element is configured to provide a network for data transmission.

In the 5G communication system, the data network element is a data network (data network, DN) network element. In the future communication system, the data network element is still a DN network element, or has another name. This is not limited in at least one embodiment.

7. Policy control network element: The policy control network element is configured to: provide guidance on a unified policy framework for network behavior, provide policy rule information for a control plane function network element (for example, an AMF or SMF network element), and the like.

In a 4G communication system, the policy control network element is a policy and charging rules function (policy and charging rules function, PCRF) network element. In the 5G communication system, the policy control network element is a policy control function (policy control function, PCF) network element. In the future communication system, the policy control network element is still a PCF network element, or has another name. This is not limited in at least one embodiment.

8. Data management network element: The data management network element is configured to: process a user equipment identifier, perform access authentication, perform registration management and mobility management, and the like.

In the 5G communication system, the data management network element is a unified data management (unified data management, UDM) network element. In the 4G communication system, the data management network element is a home subscriber server (home subscriber server, HSS) network element. In the future communication system, the data management network element is still a UDM network element, or has another name. This is not limited in at least one embodiment.

9. Data repository network element: The data repository network element is configured to: be responsible for an access function of subscription data, policy data, application data, and other types of data.

In the 5G communication system, the data repository network element is a unified data repository (unified data repository, UDR) network element. In the future communication system, the data repository network element is still a UDR element, or has another name. This is not limited in at least one embodiment.

10. Network exposure function (network exposure function, NEF) entity: The network exposure function entity is configured to: securely open, to the outside, a service and a capability that are provided by a 3GPP network function.

11. ProSe application server (application server, AS): The ProSe application server is an application function (application function, AF) of the DN, or is an AS that provides a ProSe service. An AF that has a ProSe application server function has all functions of the AF defined in 23.501 Release R-15, as well as a related function used for the ProSe service. In other words, in a user plane architecture, the ProSe application server and the UE perform user plane communication by using a path of UE-RAN-UPF-AF. The ProSe application server has communicates, in a control plane architecture by using the NEF, with another network function (network function, NF) in a 5G core network (5G core network, 5GC), for example, communicates with the PCF by using the NEF. In response to the ProSe application server is an AF of the DN, and the AF is disposed by a carrier of the 5GC, the ProSe application server further directly communicates, in the control plane architecture without using the NEF, with another NF in the 5GC, for example, directly communicates with the PCF.

12. 5G direct communication discovery name management function (direct discovery name management function, DDNMF): The 5G direct communication discovery name management function has a function of allocating and processing a mapping relationship between a proximity-based service application identifier (ProSe application identifier) and a proximity-based service application code (ProSe application code) for open proximity-based service discovery (open ProSe discovery). In restricted proximity-based service discovery (restricted ProSe direct discovery), the 5G DDNMF communicates with a proximity-based service application server through a PC2 interface, to process authorization of a discovery request (discovery request), and also has a function of not allocating and processing a mapping relationship between an application identifier (application identifier) and code used in a restricted proximity-based service. The code used in the restricted proximity-based service includes restricted proximity-based service code (ProSe restricted code), proximity-based service request code (ProSe query code), and proximity-based service reply code (ProSe response code).

In a current standard definition, the 5G DDNMF is at a PLMN granularity. To be specific, one PLMN has only one 5G DDNMF. One 5G DDNMF is uniquely identified by using mobile country code (mobile country code, MCC) and mobile network code (mobile network code, MNC).

13. Authentication server function (authentication server function, AUSF): The AUSF network element authenticates and authorizes a user.

14. Proximity-based service key management function (ProSe key management function, PKMF): The proximity-based service key management function is responsible for generating and distributing, for UE using the proximity-based service, a key used for a PC5 interface connection, and the UE interacts with the PKMF by using a control plane to obtain the key used for the PC5 interface.

The foregoing network elements or functions are network elements in a hardware device, is software functions running on dedicated hardware, or is virtualized functions instantiated on a platform (for example, a cloud platform). The foregoing network elements or functions are implemented by one device, or are jointly implemented by a plurality of devices, or are one function module in one device. This is not specifically limited in at least one embodiment.

The foregoing network architecture applicable to at least one embodiment shown in FIG. 1 is merely an example for description, and a network architecture applicable to at least one embodiment is not limited thereto. Any network architecture that implements functions of the foregoing network elements is applicable to at least one embodiment.

For example, in some network architectures, network function network element entities such as an AMF, an SMF network element, a PCF network element, and a UDM network element are all referred to as network function (network function, NF) network elements. Alternatively, in some other network architectures, a set of network elements such as an AMF, an SMF network element, a PCF network element, and a UDM network element is referred to as a control plane function network element. Because the UE interacts with the PKMF and the DDNMF by using a user plane, network elements such as the PKMF and the DDNMF are referred to as user plane network elements.

With rapid development of mobile communication, universal use of new service types, for example, data services such as video services and virtual reality (virtual reality, VR)/augmented reality (augmented reality, AR), increases a bandwidth usage of a user. D2D communication allows direct communication between UEs, and shares a spectrum resource with a cell user under control of a cell network, to effectively improve utilization of the spectrum resource. Currently, the D2D communication has been applied to the 4G network system, and is collectively referred to as proximity-based service (proximity-based service, ProSe) communication.

The D2D communication includes one-to-many communication (one to many communication) and one-to-one communication (one to one communication). The one-to-many communication corresponds to multicast and broadcast communication, and the one-to-one communication corresponds to unicast communication. In the one-to-one communication, in response to sender UE and receiver UE being in a short distance range, the sender UE and the receiver UE directly communicate with each other after mutual discovery. In the D2D communication, UE directly performs communication through a PC5 interface, to perform data-plane and signaling-plane information transmission.

In response to UE being located outside network coverage or a communication signal between the UE and a RAN being poor, remote UE (remote UE) uses relay UE (relay UE) to assist in communication. In other words, the remote UE obtains a service through communication between the remote UE and the relay UE and communication between the relay UE and a mobile network. By establishing a communication manner from the remote UE to the relay UE to the network, UE-to-network communication outside the network coverage is extended to be supported. The communication manner from the remote UE to the relay UE to the network is referred to as UE-to-network relay (UE-to-network relay) communication.

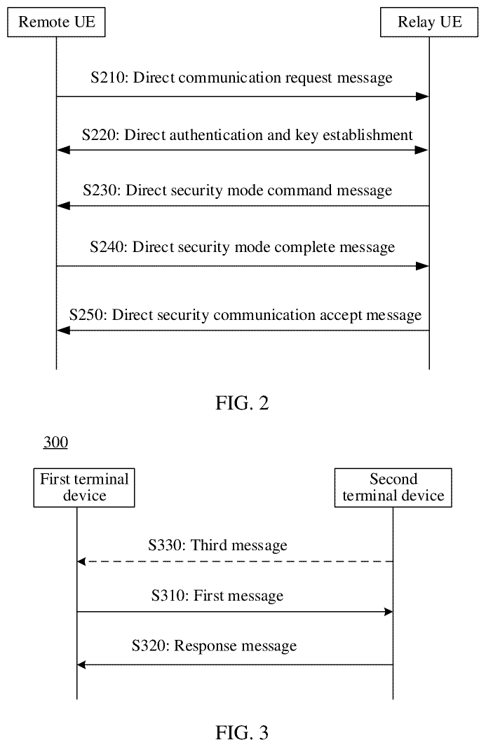

For a UE-to-network relay communication service in the ProSe, before establishing PC5 unicast communication, the remote UE and the relay UE first perform a ProSe discovery procedure, to determine peer UE in communication. After the discovery procedure, the remote UE and the relay UE perform a PC5 unicast communication security establishment procedure. A specific procedure is shown in FIG. 2. The procedure in FIG. 2 is described according to a reference technology for unicast establishment in 3GPP TS 33.536 (v16.4.0).
S210: Remote UE sends a direct communication request (direct communication request, DCR) message to relay UE to initiate establishment of PC5 unicast communication.

The direct communication request message includes random number information generated by the remote UE, and the random number information is for generating, on a network side, a PC5 key used for the PC5 unicast communication and a control plane security protection policy (signaling security policy) of the remote UE. A security capability of UE is a security protection algorithm supported by the UE, and the security protection algorithm includes a confidentiality protection algorithm and/or an integrity protection algorithm.
S220: The remote UE and the relay UE perform a direct authentication and key establishment procedure.

In the UE-to-network communication service scenario in the ProSe, the direct authentication and key establishment procedure performed between the remote UE and the relay UE are completed by using the network side. To be specific, in the direct authentication and key establishment procedure, the relay UE interacts with the network side to obtain a PC5 key used for the PC5 unicast communication.
S230: The relay UE sends a direct security mode (direct security mode, DSM) command (command) message to the remote UE.

After receiving the direct communication request message from the remote UE, the relay UE first determines a control plane security protection enabling manner based on control plane security protection policies of the two UEs. In response to the security protection being enabled, the relay UE interacts with the network side to perform the direct authentication and key establishment procedure in step S220 to obtain the PC5 key. Further, the relay UE sends the direct security mode command message to the remote UE, where the direct security mode command message includes a selected security protection algorithm, and the security protection algorithm includes a confidentiality protection algorithm and an integrity protection algorithm.

The direct security mode command message carries key derivation information or a key identifier obtained from the network side. The remote UE derives the PC5 key by using the key derivation information, or the remote UE determines the PC5 key based on the key identifier. The PC5 key is the same as the PC5 key obtained by the relay UE from the network side.
S240: The remote UE sends a direct security mode complete (complete) message to the relay UE.

After the remote UE receives the direct security mode command message from the relay UE, in response to the security protection enabling manner implicitly indicated by the selected security algorithm carried in the direct security mode command message meeting the control plane security protection policy of the local end, the remote UE sends the direct security mode complete message to the relay UE. The direct security mode complete message includes a user plane security protection policy (user plane security policy) of the remote UE.
S250: The relay UE sends a direct communication accept (direct communication accept, DCA) message to the remote UE.

After the relay UE receives the direct security mode complete message from the remote UE, the relay UE determines a user plane security protection enabling manner based on user plane security protection policies of the two UEs. Further, the relay UE sends a direct communication accept message to the remote UE, where the direct communication accept message includes user plane security configuration (user plane security configuration) information, and is for notifying UE #1 of the selected user plane security protection enabling manner.

In S220, the remote UE and the relay UE share the key through mutual authentication and negotiation. Currently, there are two solutions for negotiating the PC5 key in UE-to-network relay communication: a control plane-based solution and a user plane-based solution. In the control plane-based solution, a PC5 shared key is derived based on a key generated after primary authentication is performed between remote UE and a 3GPP network. In the user plane-based solution, a ProSe key management function (ProSe key management function, PKMF) for key generation, management, and distribution is to be deployed, and UE obtains a PC5 key from the PKMF by using the user plane. However, in a process in which the remote UE and the relay UE establish the PC5 unicast connection, how to determine a solution of negotiating the PC5 key is not resolved. To be specific, currently, a condition based on which to select the control plane-based solution or the user plane-based solution to obtain the PC5 key is not determined.

In view of this, at least one embodiment provides a method for determining a key obtaining manner, to resolve a problem of how to determine a manner of obtaining a PC5 key.

A specific structure of an execution body of a method provided in at least one embodiment is not specifically limited in embodiments shown herein, provided that a program that records code of the method provided in at least one embodiment is run to perform communication according to the method provided in at least one embodiment. For example, the method provided in at least one embodiment is performed by a terminal device, a core network device, or a function module that invokes and executes the program and that is in the terminal device or the core network device.

Without loss of generality, the following describes in detail the key determining method provided in at least one embodiment by using interaction between the terminal device or the core network device as an example.

FIG. 3 is a schematic flowchart of a method for determining a key obtaining manner according to at least one embodiment. As shown in FIG. 3, the method 300 includes S310 to S330. The following describes the steps in detail.
S310: A first terminal device sends a first message. Correspondingly, in S310, a second terminal device receives the first message.

The first terminal device is a remote terminal device, and the second terminal device is a relay terminal device: or the first terminal device is a relay terminal device, and the second terminal device is a remote terminal device.

The first message includes first indication information, and the first indication information indicates to obtain a first PC5 key in a control plane manner. The first PC5 key is a key used for a PC5 link between the first terminal device and the second terminal device. The first indication information is explicit indication information, for example, dedicated indication information. Alternatively, a specific parameter specific to obtaining the first PC5 key in the control plane manner is used to implicitly indicate to obtain the first PC5 key in the control plane manner. For example, the first message carries a parameter A in response to the first PC5 key being obtained in the control plane manner, and the first message not including the parameter A in response to the first PC5 key being obtained in the user plane manner. In this case, the parameter A is the first indication information, and the first message carries the parameter A implicitly indicates to obtain the first PC5 key in the control plane manner.

Obtaining the first PC5 key in the control plane manner means that the relay terminal device obtains, through interaction with a key management network element in a network by using the control plane, PC5 key information and information used for generating the first PC5 key. The relay terminal device directly obtains the first PC5 key from the PC5 key information. The relay terminal device sends, to the remote terminal device, the information used for generating the PC5 key, and the remote terminal device determines the first PC5 key based on the information used for generating the PC5 key. Obtaining the first PC5 key in the user plane manner means that the relay terminal device obtains, through interaction with a key management network element in a network by using the user plane, PC5 key information and information used for generating the PC5 key. The relay terminal device directly obtains the first PC5 key from the PC5 key information. The relay terminal device sends, to the remote terminal device, the information used for generating the PC5 key, and the remote terminal device determines the first PC5 key based on the information used for generating the PC5 key. Information used for generating the PC5 key is random number information or PC5 key identifier information. The information used for generating the PC5 key in the control plane manner and the information used for generating the PC5 key in the user plane manner is different or the same.

Specifically, in S310, in response to a preset condition being met, the first terminal device sends the first message to the second terminal device.

For example, the preset condition includes one or more of the following: a first PLMN identifier (identifier, ID) of a home network of the first terminal device is inconsistent with a second PLMN ID of a home network of the second terminal device, a first relay service code (relay service code, RSC) used by the first terminal device in a proximity direct discovery (ProSe direct discovery) procedure corresponds to a layer-2 UE-to-network relay communication service, a second RSC used by the second terminal device in a proximity direct discovery procedure corresponds to the layer-2 UE-to-network relay communication service, key information that is obtained by the first terminal device from a key management network element and that is for determining the first PC5 key expires, and the first terminal device has not obtained the key information. The key information for determining the first PC5 key includes the first PC5 key and/or an identifier of the first PC5 key. For example, the key management network element is a PKMF, an AUSF, or an AMF. In response to the first PC5 key being obtained in the user plane manner, the key management network element is the PKMF. In response to the first PC5 key being obtained in the control plane manner, the key management network element is the AUSF or the AMF.

In response to the first terminal device determining that the first PC5 key is obtained in the control plane manner and the user plane manner, the first terminal device determines, depending on whether the preset condition is met, whether to obtain the first PC5 key in the control plane manner. In response to the preset condition being met, the first terminal device determines to obtain the first PC5 key in the control plane manner: or in response to none of the preset conditions being met, the first terminal device determines to obtain the first PC5 key in the control plane manner or the user plane manner. Further, in response to the first terminal device determining to obtain the first PC5 key in the control plane manner, the first terminal device sends, to the second terminal device, a first message that carries the first indication information: or in response to the first terminal device determining to obtain the first PC5 key in the user plane manner, the first terminal device sends, to the second terminal device, a first message that does not carry the first indication information, or sends, to the second terminal device, a first message that carries fourth indication information, where the fourth indication information indicates to obtain the first PC5 key in the user plane manner. That the preset condition is met means that at least one of the preset conditions is met.

Optionally, in response to at least one of the preset conditions being met, the first indication information indicates to obtain the first PC5 key in the user plane manner. The first PC5 key is a key used for a PC5 link between the first terminal device and the second terminal device. The preset condition includes one or more of the following: the first PLMN ID is consistent with the second PLMN ID, the first RSC used by the first terminal device in the proximity direct discovery procedure corresponds to a layer-3 UE-to-network relay communication service using a non-3GPP interworking function (non-3GPP interworking function, N3IWF) for access, and the first RSC used by the first terminal device in the proximity direct discovery procedure corresponds to the layer-3 UE-to-network relay communication service: the first terminal device has obtained the key information from a key management network element that obtains the first PC5 key in the user plane manner.

In at least one embodiment, the first terminal device determines, based on predefinition in a protocol or default configuration of a device, that the first PC5 key is obtained in the control plane manner and the user plane manner. The predefinition in the protocol or the default configuration of the device explicitly indicates to obtain the first PC5 key in the control plane manner and the user plane manner, or implicitly indicates to obtain the first PC5 key in the control plane manner and the user plane manner. In this case, the implicit method is not defining or limiting the manner of obtaining the first PC5 key. To be specific, before step S310 is performed, the first terminal does not determine, by using the predefinition in the protocol, the default configuration of the device, or information by received from the network side, the manner of obtaining the first PC5 key.

In at least one embodiment, the first terminal device determines, based on the first information, that the first PC5 key is obtained in the control plane manner and the user plane manner. The first information is for determining the manner of obtaining the first PC5 key.

For example, the first information indicates that the PC5 key is obtained in the control plane manner and the user plane manner. Correspondingly, the first terminal device determines, based on the first information, that the first PC5 key is obtained in the control plane manner and the user plane manner. The first information corresponds to the first PLMN ID, and the first information does not indicate a correspondence between the first information and the first PLMN ID, that is, the first information does not include identifier information that indicates the first PLMN ID. For example, the first information is indication information obtained by a network element and/or UE in a PLMN corresponding to the first PLMN ID.

For another example, the first information includes a first mapping relationship, the first mapping relationship includes a correspondence between at least one piece of indication information and at least one PLMN ID, each of the at least one piece of indication information indicates to obtain the PC5 key in the control plane manner and/or the user plane manner, and the at least one PLMN ID includes the first PLMN ID and/or the second PLMN ID. Correspondingly, the first terminal device determines, based on second indication information, that the first PC5 key is obtained in the control plane manner and the user plane manner, the second indication information indicates to obtain the PC5 key in the control plane manner and the user plane manner, and the second indication information is indication information that is in the at least one piece of indication information and that corresponds to the first PLMN ID or the second PLMN ID. For example, in response to the first mapping relationship including the first PLMN ID and indication information corresponding to the first PLMN ID, the second indication information is the indication information corresponding to the first PLMN ID. In other words, in this case, the first mapping relationship includes a mapping relationship between the second indication information and the first PLMN ID. For another example, in response to the first mapping relationship including the second PLMN ID and indication information corresponding to the second PLMN ID, the second indication information being the indication information corresponding to the second PLMN ID. In other words, in this case, the first mapping relationship includes a mapping relationship between the second indication information and the second PLMN ID. For still another example, in response to the first mapping relationship including the first PLMN ID, indication information corresponding to the first PLMN ID, the second PLMN ID, and indication information corresponding to the second PLMN ID, the second indication information is the indication information corresponding to the first PLMN ID and the indication information corresponding to the second PLMN ID. In other words, in this case, the first mapping relationship includes a mapping relationship between the second indication information and the second PLMN ID or the first PLMN ID.

Optionally, in response to the second indication information corresponding to the first PLMN ID, the first PC5 key is generated by a network element in the first PLMN. In response to the second indication information corresponding to the second PLMN ID, the first PC5 key is generated by a network element in the second PLMN.

For still another example, the first information includes a second mapping relationship, the second mapping relationship includes a correspondence between at least one piece of indication information and identifier information of at least one relay service, each of the at least one piece of indication information indicates to obtain the PC5 key in the control plane manner and the user plane manner, the at least one relay service includes a first relay service, and the first relay service corresponds to the PC5 link between the first terminal device and the second terminal device, that is, the PC5 link is established for the first relay service. The identifier information of the relay service identifies a specific proximity-based service (ProSe service), and the identifier information of the relay service is an RSC, or is service name information, for example, a service identifier (service identifier). Correspondingly, the first terminal device determines, based on the second indication information, that the first PC5 key is obtained in the control plane manner and the user plane manner, the second indication information indicates to obtain the PC5 key in the control plane manner and the user plane manner, and the second indication information is indication information that is in the at least one piece of indication information and that corresponds to identifier information of the first relay service. Each of the at least one relay service is a UE-to-network relay communication service.

In response to the first information including the first mapping relationship, in addition to the correspondence between the first PLMN ID and the second indication information or the mapping relationship between the second PLMN ID and the second indication information, the first mapping relationship further includes a mapping relationship between a PLMN ID and indication information that indicates a manner of obtaining the PC5 key and that is in all PLMNs that have a roaming agreement with a carrier of the home network of the first terminal device. In response to the first information including the second mapping relationship, in addition to a mapping relationship between the identifier information of the first relay service and the second indication information, the second mapping relationship further includes a mapping relationship between relay service identifier information of all relay services that is used by the first terminal device and corresponding indication information that indicates a manner of obtaining the PC5 key.

A manner in which the first terminal device obtains the first information is not limited in at least one embodiment.

In an example, the first terminal device obtains a ProSe parameter from a PCF, where the ProSe parameter includes the first information. With reference to a method 800, the following describes in detail how the first terminal device obtains, from the PCF, the ProSe parameter including the first information. For brevity, details are not described herein.

In another example, the first terminal device obtains the first information from an AF or an AS. To be specific, after registering with the network and establishing a link to the AF or the AS, the first terminal device obtains the first information from the AF or the AS. The link from the first terminal device to the AF or the AS is a user plane link. The first information obtained by the first terminal device from the AF or the AS includes the first mapping relationship or the second mapping relationship.

In still another example, the first terminal device obtains the first information locally. For example, the first terminal device obtains the first information from a universal integrated circuit card (universal integrated circuit card, UICC), or the first terminal device obtains the first information from a mobile terminal (mobile terminal, MT) corresponding to the first terminal device or mobile equipment (mobile equipment, ME) corresponding to the first terminal device, where the first terminal device includes a UICC and an MT, or the first terminal device includes a UICC and ME. In response to the first information indicating that the PC5 key is obtained in the control plane manner and the user plane manner, the first information is preconfigured in the first terminal device by the carrier of the home network of the first terminal device: in response to the first information including the first mapping relationship, the carrier of the home network of the first terminal device preconfigures a correspondence between indication information and a PLMN ID in the first terminal device, where the carrier of the home network of the first terminal device obtains, in advance, the indication information that indicates the manner of obtaining the PC5 key and that is in all PLMNs that have a roaming agreement with the carrier of the home network of the first terminal device: or in response to the first information including the second mapping relationship, service providers of different relay services preconfigure correspondences between indication information and identifier information of the relay services in the first terminal device by using the carrier of the home network of the first terminal device.

Optionally, before S310, the method 300 further includes S330: The second terminal device sends a second message to the first terminal device, where the second message includes the second PLMN ID and the second RSC.
S320: The second terminal device sends a response message of the first message. Correspondingly, in S320, the first terminal device receives the response message of the first message.

The response message indicates, to the first terminal device, whether the second terminal device obtains the first PC5 key, or the response message indicates, to the first terminal device, whether the second terminal device obtains the first PC5 key in the control plane manner.

Optionally, in response to the first indication information further indicating to obtain the first PC5 key in the user plane manner, the response message indicates, to the first terminal device, whether the second terminal device obtains the first PC5 key, or the response message indicates, to the first terminal device, whether the second terminal device obtains the first PC5 key in the user plane manner.

Specifically, in S320, in response to the second terminal device determining that the first PC5 key is obtained in the control plane manner or the user plane manner, the response message sent by the second terminal device to the first terminal device indicates, to the first terminal device, that the second terminal device obtains the first PC5 key, or the response message indicates, to the first terminal device, that the second terminal device obtains the first PC5 key in the control plane manner or the user plane manner: or in response to the second terminal device determining that the first PC5 key cannot be obtained in the control plane manner or the user plane manner, the response message sent by the second terminal device to the first terminal device indicates, to the first terminal device, that the second terminal device cannot obtain the first PC5 key, or the response message indicates, to the first terminal device, that the second terminal device cannot obtain the first PC5 key in the control plane manner or the user plane manner.

Optionally, in S320, in response to the second terminal device determining that the first PC5 key is obtained in the control plane manner or the user plane manner, the second terminal device sends the response message of the first message to the first terminal device, where the response message indicates, to the first terminal device, that the second terminal device obtains the first PC5 key, or the response message indicates, to the first terminal device, that the second terminal device obtains the first PC5 key in the control plane manner or the user plane manner. In response to the second terminal device determining that the first PC5 key cannot be obtained in the control plane manner or the user plane manner, the second terminal device does not send the response message of the first message to the first terminal device.

In response to the second terminal device determining that the first PC5 key is obtained in the control plane manner or the user plane manner, the response message sent by the second terminal device to the first terminal device does not necessarily explicitly indicate that the second terminal device obtains the first PC5 key. Once the second terminal device sends the response message of the first message to the first terminal device, the second terminal device obtains the first PC5 key by default.

The manner in which the second terminal device determines the manner of obtaining the first PC5 key is not limited in at least one embodiment.

In at least one embodiment, the second terminal device determines, based on predefinition in a protocol or default configuration of a device, that the first PC5 key is obtained in the control plane manner and/or the user plane manner. The predefinition in the protocol or the default configuration of the device explicitly indicates to obtain the first PC5 key in the control plane manner and/or the user plane manner, or implicitly indicates to obtain the first PC5 key in the control plane manner and/or the user plane manner. In this case, the implicit method is not defining or limiting the manner of obtaining the first PC5 key. To be specific, before step S320 is performed, the second terminal device does not determine, by using the predefinition in the protocol, the default configuration of the device, or information by received from the network side, the manner of obtaining the first PC5 key.

In at least one embodiment, the second terminal device determines, based on the second information, that the first PC5 key is obtained in the control plane manner and/or the user plane manner. The second information is for determining the manner of obtaining the first PC5 key.

For example, the second information indicates that the PC5 key is obtained in the control plane manner and/or the user plane manner. Correspondingly, the second terminal device determines, based on the second information, that the first PC5 key is obtained in the control plane manner and/or the user plane manner. For example, in response to the second information indicating that the PC5 key is obtained in the control plane manner or the user plane manner, the second terminal device determines that the first PC5 key is obtained in the control plane manner or the user plane manner: or in response to the second information indicating that the PC5 key is obtained in the control plane manner and the user plane manner, the second terminal device determines that the first PC5 key is obtained in the control plane manner and the user plane manner. The second information corresponds to the second PLMN ID, and the second information does not indicate a correspondence between the second information and the second PLMN ID, that is, the second information does not include identifier information that indicates the second PLMN ID. For example, the second information is indication information obtained by a network element and/or UE in a PLMN corresponding to the second PLMN ID.

For another example, the second information includes a third mapping relationship, the third mapping relationship includes a correspondence between at least one piece of indication information and at least one PLMN ID, each of the at least one piece of indication information indicates to obtain the PC5 key in the control plane manner and/or the user plane manner, and the at least one PLMN ID includes the first PLMN ID and/or the second PLMN ID. Correspondingly, the first terminal device determines, based on the third indication information, the manner of obtaining the first PC5 key, the third indication information indicates to obtain the PC5 key in the control plane manner and/or the user plane manner, and the third indication information is indication information that is in the at least one piece of indication information and that corresponds to the first PLMN ID or the second PLMN ID. For example, in response to the third mapping relationship including the first PLMN ID and indication information corresponding to the first PLMN ID, the third indication information is the indication information corresponding to the first PLMN ID. In other words, in this case, the third mapping relationship includes a mapping relationship between the third indication information and the first PLMN ID. For another example, in response to the third mapping relationship including the second PLMN ID and indication information corresponding to the second PLMN ID, the third indication information is the indication information corresponding to the second PLMN ID. In other words, in this case, the third mapping relationship includes a mapping relationship between the third indication information and the second PLMN ID. For still another example, in response to the third indication information including the first PLMN ID, indication information corresponding to the first PLMN ID, the second PLMN ID, and indication information corresponding to the second PLMN ID, the third indication information is the indication information corresponding to the first PLMN ID and the indication information corresponding to the second PLMN ID. In other words, in this case, the third mapping relationship includes a mapping relationship between the third indication information and the second PLMN ID or the first PLMN ID.

Optionally, in response to the third indication information corresponding to the first PLMN ID, the first PC5 key is generated by a network element in the first PLMN. In response to the third indication information corresponding to the second PLMN ID, the first PC5 key is generated by a network element in the second PLMN.

For still another example, the second information includes a fourth mapping relationship, the fourth mapping relationship includes a correspondence between at least one piece of indication information and identifier information of at least one relay service, each of the at least one piece of indication information indicates to obtain the PC5 key in the control plane manner and/or the user plane manner, the at least one relay service includes a first relay service, and the first relay service corresponds to the PC5 link between the first terminal device and the second terminal device, that is, the PC5 link is established for the first relay service. The identifier information of the relay service identifies a specific proximity-based service, and the identifier information of the relay service is an RSC, or is service name information, for example, a service identifier. Correspondingly, the first terminal device determines, based on the third indication information, that the first PC5 key is obtained in the control plane manner and/or the user plane manner, the third indication information indicates to obtain the PC5 key in the control plane manner and/or the user plane manner, and the third indication information is indication information that is in the at least one piece of indication information and that corresponds to identifier information of the first relay service. Each of the at least one relay service is a UE-to-network relay communication service.

In response to the second information including the third mapping relationship, in addition to the correspondence between the first PLMN ID and the third indication information or the correspondence between the second PLMN ID and the third indication information, the third mapping relationship further includes a correspondence between a PLMN ID and indication information that indicates a manner of obtaining the PC5 key and that is in all PLMNs that have a roaming agreement with a carrier of the home network of the second terminal device. In response to the second information including the fourth mapping relationship, in addition to a correspondence between the identifier information of the first relay service and the third indication information, the fourth mapping relationship further includes a correspondence between relay service identifier information of all relay services that is used by the second terminal device and corresponding indication information that indicates the manner of obtaining the PC5 key.

A manner in which the second terminal device obtains the second information is not limited in at least one embodiment.

In an example, the second terminal device obtains a ProSe parameter from a PCF, where the ProSe parameter includes the second information. With reference to the method 800, the following describes in detail how the second terminal device obtains, from the PCF, the ProSe parameter including the second information. For brevity, details are not described herein.

In another example, the second terminal device obtains the second information from an AF or an AS. To be specific, after registering with the network and establishing a link to the AF or the AS, the second terminal device obtains the second information from the AF or the AS. The link from the second terminal device to the AF or the AS is a user plane link. The second information obtained by the second terminal device from the AF or the AS includes the third mapping relationship or the fourth mapping relationship.

In still another example, the second terminal device obtains the second information locally. For example, the second terminal device obtains the second information from a UICC, or the second terminal device obtains the second information from an MT or ME corresponding to the second terminal device, where the second terminal device includes the UICC and the MT, or the second terminal device includes the UICC and the ME. In response to the second information indicating that the PC5 key is obtained in the control plane manner and/or the user plane manner, the second information is preconfigured in the second terminal device by the carrier of the home network of the second terminal device: in response to the second information including the third mapping relationship, the carrier of the home network of the second terminal device preconfigures a correspondence between indication information and a PLMN ID in the second terminal device, where the carrier of the home network of the second terminal device obtains, in advance, the indication information that indicates the manner of obtaining the PC5 key and that is in all PLMNs that have a roaming agreement with the carrier of the home network of the second terminal device; or in response to the second information including the fourth mapping relationship, service providers of different relay services preconfigure correspondences between indication information and identifier information of the relay services in the first terminal device by using the carrier of the home network of the second terminal device.

In at least one embodiment, the first terminal device determines, based on whether at least one of the preset conditions is met, whether to obtain the first PC5 key in the control plane manner, so that the first terminal device and the second terminal device obtains the first PC5 key in different manners in different scenarios, to obtain the PC5 key in a manner with lower signaling overheads and fewer wasted resources, to improve efficiency and a success rate of establishing the PC5 link.

For example, in response to the first terminal device and the second terminal device being terminal devices of different PLMNs, because a remote terminal device in the first terminal device and the second terminal device cannot access an internal network element in another PLMN by using a user plane, in response to the first PLMN ID being inconsistent with the second PLMN ID, the first terminal device determines to obtain the first PC5 key in the control plane manner, and sends the first indication information to the second terminal device, to ensure that the first terminal device and the second terminal device successfully obtain the first PC5 key and successfully establish the PC5 link.

For another example, in a layer-2 UE-to-network relay communication service scenario, a relay terminal device is not responsible for establishing a PDU session for a remote terminal device. In response to the first PC5 key being obtained in the user plane manner, processing burden and processing logic of the relay terminal device are additionally increased. Therefore, in response to the first RSC or the second RSC corresponding to the layer-2 UE-to-network relay communication service, the first terminal device determines to obtain the first PC5 key in the control plane manner, and sends the first indication information to the second terminal device, so that the increase of processing logic and processing burden of the relay terminal device in the first terminal device and the second terminal device is avoided.

For another example, in the user plane manner, the remote terminal device obtains the key information from the key management network element in advance, and the key information distributed by the key management network element has a corresponding validity period. To be specific, after the key information expires, the remote terminal device cannot obtain the PC5 key, or the remote terminal device obtains the key information from the key management network element again. In response to the remote terminal device not being in network coverage, the remote terminal device cannot obtain the key information from the key management network element. Therefore, in response to the key information obtained by the first terminal device from the key management network element expiring, or the first terminal device not obtaining the key information, the first terminal device determines to obtain the first PC5 key in the control plane manner, and sends the first indication information to the second terminal device. This ensures that the first terminal device and the second terminal device successfully obtain the first PC5 key and successfully establish the PC5 link.

In at least one embodiment, the first terminal device determines, based on whether at least one of the preset conditions is met, whether to obtain the first PC5 key in the user plane manner, so that the first terminal device and the second terminal device obtains the first PC5 key in different manners in different scenarios, to obtain the PC5 key in a manner with lower signaling overheads and fewer wasted resources, to improve efficiency and a success rate of establishing the PC5 link.

For example, in a layer-3 UE-to-network relay communication service scenario or a layer-3 UE-to-network relay communication service using an N3IWF for access, a relay terminal device is to be responsible for establishing a PDU session for a remote terminal device. In response to the first PC5 key being obtained in the control plane manner, the relay terminal device performs additional control plane signaling exchange with the network, processing burden and processing logic of the relay terminal device are increased. Therefore, in consideration of consistency of processing manners, the first terminal device determines to obtain the first PC5 key in the user plane manner, and sends the first indication information to the second terminal device. This ensures consistency of the processing manners in which the first terminal device and the second terminal device generate the PC5 key.

For another example, in the user plane manner, the remote terminal device obtains the key information from the key management network element in advance. In response to the remote terminal device obtaining the PC5 key from the key management network element that obtains the first PC5 key in the user plane manner, and in response to the first PC5 key being obtained in the control plane manner, the remote terminal device subsequently continues to generate the PC5 key by using another key. Consequently, processing burden, key storage burden, and processing logic of the remote terminal device are increased. In this case, the first terminal device determines to obtain the first PC5 key in the user plane manner, and sends the first indication information to the second terminal device. This ensures consistency of the processing manners in which the first terminal device and the second terminal device generate the PC5 key.

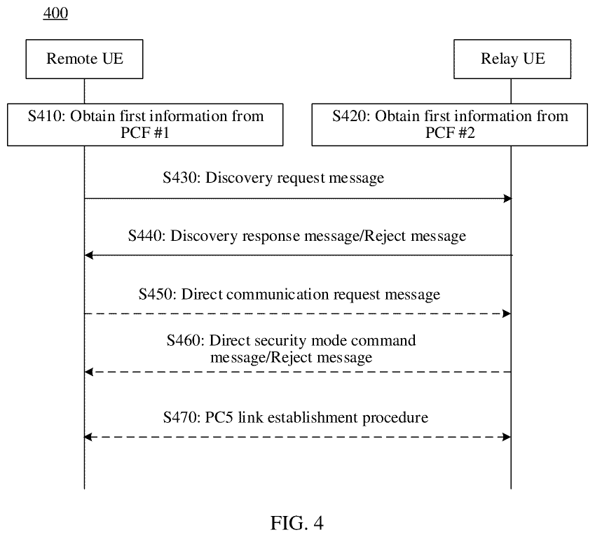

The following describes four scenarios to which the method 300 is applicable with reference to FIG. 4 to FIG. 7.

FIG. 4 is a schematic flowchart of a method for determining a key obtaining manner according to at least one embodiment. A method 400 shown in FIG. 4 is a specific implementation of the method 300. Remote UE shown in FIG. 4 is the first terminal device in the foregoing method 300, and relay UE is the second terminal device in the foregoing method 300. The following describes steps included in the method 400.
S410: The remote UE obtains first information from PCF #1.

PCF #1 provides a service for the remote UE. For descriptions of the first information, refer to the foregoing S310. For descriptions of how the remote UE obtains the first information from PCF #1, refer to the following method 800.
S420: The relay UE obtains second information from PCF #2.

PCF #2 provides a service for the relay UE. For descriptions of the second information, refer to the foregoing S320. For descriptions of how the relay UE obtains the second information from PCF #2, refer to the following method 800.

PCF #1 and PCF #2 are a same PCF network element, or is different PCF network elements. In response to the remote UE and the relay UE having a same home PLMN, PCF #1 and PCF #2 being a same PCF network element. In response to the remote UE and the relay UE having different home PLMNs, PCF #1 and PCF #2 are different PCF network elements.
S430: The remote UE sends a discovery request message (an example of the first message) to the relay UE.

In response to the remote UE determining, based on the first information, that a first PC5 key is obtained in a control plane manner and a user plane manner, the remote UE determines, depending on whether a preset condition is met, whether to obtain the first PC5 key in the control plane manner. In response to the preset condition being met, the remote UE determines to obtain the first PC5 key in the control plane manner: or in response to none of the preset conditions being met, the remote UE obtains the first PC5 key in the control plane manner or the user plane manner. The first PC5 key is a key used for a PC5 link between the remote UE and the relay UE. For descriptions of the manner in which the remote UE determines, based on the first information, to obtain the first PC5 key, refer to the foregoing S310. That the preset condition is met means that at least one of the preset conditions is met.

The preset condition includes one or more of the following: a first RSC used by the remote UE in a proximity direct discovery procedure corresponds to a layer-2 UE-to-network relay communication service, key information that is obtained by the remote UE from a key management network element and that is for determining the first PC5 key expires, or the remote UE has not obtained the key information.

Further, in response to the remote UE determining to obtain the first PC5 key in the control plane manner, the discovery request message sent to the relay UE includes first indication information, and the first indication information indicates to obtain the first PC5 key in the control plane manner. For more descriptions of the first indication information, refer to the foregoing S310.

The discovery request message is a discovery request message sent by discoverer (discoverer) UE in a Model B discovery model.
S440: The relay UE sends a discovery response message (an example of the response message of the first message) or a reject (reject) message (an example of the response message of the first message) to the remote UE.

In response to the relay UE determining, based on the second information, that the first PC5 key is obtained in the control plane manner, the relay UE sends the discovery response message to the remote UE. The discovery response message includes a second RSC used by the relay UE in a proximity direct discovery procedure. Optionally, the discovery response message further includes a second PLMN ID of a home network of the relay UE.

In response to the relay UE determining, based on the second information, that the first PC5 key cannot be obtained in the control plane manner, the relay UE does not send the discovery response message to the remote UE, or the relay UE sends the reject message to the remote UE. Optionally, the reject message indicates that the relay UE cannot obtain the first PC5 key, or the reject message indicates that the relay UE cannot obtain the first PC5 key in the control plane manner.

For descriptions of the manner in which the relay UE determines, based on the second information, to obtain the first PC5 key, refer to the foregoing S320.

The discovery response message is a discovery request message sent by discoveree (discoveree) UE in the Model B discovery model.
S450: The remote UE sends a direct communication request message (an example of the first message) to the relay UE.

In response to the remote UE receiving the discovery response message in S440, the remote UE sends a direct communication request message to the relay UE.

Optionally, in response to the discovery request message sent by the remote UE to the relay UE in S430 not including the first indication information, before the remote UE sends the direct communication request message to the relay UE, the remote UE determines, depending on whether the second RSC corresponds to the layer-2 UE-to-network relay communication service, whether to obtain the first PC5 key in the control plane manner. In response to the second RSC corresponding to the layer-2 UE-to-network relay communication service, the remote UE determines to obtain the first PC5 key in the control plane manner, and carries the first indication information in the direct communication request message.

Optionally, in response to the discovery response message including the second PLMN ID, the remote UE further determines, depending on whether a first PLMN ID of a home network of the remote UE is consistent with the second PLMN ID, whether to obtain the first PC5 key in the control plane manner. In response to the first PLMN ID being inconsistent with the second PLMN ID, the remote UE determines to obtain the first PC5 key in the control plane manner, and carries the first indication information in the direct communication request message.

Optionally, in response to the discovery response message including the second PLMN ID, the remote UE further determines, depending on whether the key information that is obtained from the key management network element corresponding to the second PLMN ID and that is for determining the first PC5 key expires and/or whether the remote UE has obtained the key information from the key management network element corresponding to the second PLMN, whether to obtain the first PC5 key in the control plane manner. In response to the key information that is obtained by the remote UE from the key management network element corresponding to the second PLMN ID and being for determining that the first PC5 key expires, or the remote UE not obtaining the key information from the key management network element corresponding to the second PLMN, the remote UE determines to obtain the first PC5 key in the control plane manner, and carries the first indication information in the direct communication request message. For more descriptions of the first indication information, refer to the foregoing S310.

The direct communication request is a DCR message for initiating establishment of the PC5 link.
S460: The relay UE sends a direct security mode command message (an example of the response message of the first message) or a reject message to the remote UE.

In response to the direct communication request message including the first indication information, in response to the relay UE determining, based on the second information, that the first PC5 key is obtained in the control plane manner, the relay UE sends the direct connection mode security command message to the remote UE: or in response to the relay UE determining, based on the second information, that the first PC5 key cannot be obtained in the control plane manner, the relay UE does not send the direct security mode command message to the remote UE, or the relay UE sends the reject message to the remote UE.

The direct security mode command is a direct security mode command message in a PC5 link establishment process.
S470: The remote UE and the relay UE continue to perform the PC5 link establishment procedure.

In response to the relay UE sending the direct security mode command message to the remote UE, the remote UE and the relay UE continue to perform the PC5 link establishment procedure.

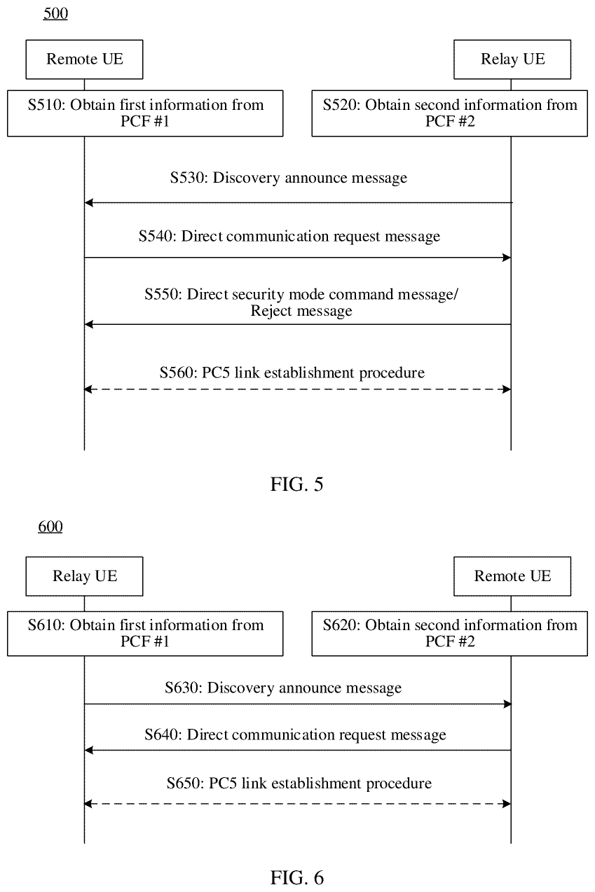

FIG. 5 is a schematic flowchart of a method for determining a key obtaining manner according to at least one embodiment. A method 500 shown in FIG. 5 is a specific implementation of the method 300. Remote UE shown in FIG. 5 is the first terminal device in the foregoing method 300, and relay UE is the second terminal device in the foregoing method 300. The following describes steps included in the method 500.
S510 and S520 are the same as S410 and S420 in the method 400.
S530: The relay UE sends a discovery announce message (an example of the third message) to the remote UE.

The discovery announce message includes a second RSC used by the relay UE in a proximity direct discovery procedure. Optionally, the discovery announce message further includes a second PLMN ID of a home network of the relay UE.

The discovery request message is a discovery announcing message sent by announcing (announcing) UE in a Model A discovery model.
S540: The remote UE sends a direct communication request message (an example of the first message) to the relay UE.

In response to the remote UE determining, based on the discovery announce message, that the relay UE provides a first service used by the remote UE, the remote UE sends the direct communication request message to the relay UE. Before the remote UE sends the direct communication request message to the relay UE, in response to the remote UE determining, based on the first information, that a first PC5 key is obtained in a user plane manner and a control plane manner, the remote UE determines, depending on whether a preset condition is met, whether to obtain the first PC5 key in the control plane manner. In response to the preset condition being met, the remote UE determines to obtain the first PC5 key in the control plane manner: or in response to none of the preset conditions being met, the remote UE determines to obtain the first PC5 key in the control plane manner or the user plane manner. The first PC5 key is a key used for a PC5 link between the remote UE and the relay UE. For descriptions of the manner in which the remote UE determines, based on the first information, to obtain the first PC5 key, refer to the foregoing S310. That the preset condition is met means that at least one of the preset conditions is met.

The preset condition includes one or more of the following: a first RSC used by the remote UE in a proximity direct discovery procedure corresponds to a layer-2 UE-to-network relay communication service, the second RSC corresponds to the layer-2 UE-to-network relay communication service, key information that is obtained by the remote UE from a key management network element and that is for determining the first PC5 key expires, or the remote UE has not obtained the key information.

Optionally, in response to the discovery response message including the second PLMN ID, the remote UE further determines, based on one or more of the following preset conditions, whether to obtain the first PC5 key in the control plane manner: key information that is obtained by the remote UE from a key management network element corresponding to a first PLMN ID of a home network of the remote UE and that is for determining the first PC5 key expires, key information obtained by the remote UE from a key management network element corresponding to the second PLMN ID expires, the first terminal device has not obtained key information from the key management network element corresponding to the first PLMN ID or the second PLMN ID, or the first PLMN ID is inconsistent with the second PLMN ID.

Further, in response to the remote UE determining to obtain the first PC5 key in the control plane manner, the direct communication request message sent to the relay UE includes first indication information, and the first indication information indicates to obtain the first PC5 key in the control plane manner. For more descriptions of the first indication information, refer to the foregoing S310.

The direct communication request is a DCR message for initiating establishment of the PC5 link.
S550: The relay UE sends a direct security mode command message (an example of the response message of the first message) or a reject message (an example of the response message of the first message) to the remote UE.

In response to the relay UE determining, based on the second information, that the first PC5 key is obtained in the control plane manner, the relay UE sends the direct security mode command message to the remote UE.

In response to the relay UE determining, based on the second information, that the first PC5 key cannot be obtained in the control plane manner, the relay UE does not send the direct security mode command message to the remote UE, or the relay UE sends the reject message to the remote UE. Optionally, the reject message indicates that the relay UE cannot obtain the first PC5 key, or the reject message indicates that the relay UE cannot obtain the first PC5 key in the control plane manner.

For descriptions of the manner in which the relay UE determines, based on the second information, to obtain the first PC5 key, refer to the foregoing S320.

The direct security mode command is a direct security mode command message in a PC5 link establishment process.
S560: The remote UE and the relay UE continue to perform the PC5 link establishment procedure.

In response to the relay UE sending the direct security mode command message to the remote UE, the remote UE and the relay UE continue to perform the PC5 link establishment procedure.

FIG. 6 is a schematic flowchart of a method for determining a key obtaining manner according to at least one embodiment. A method 600 shown in FIG. 6 is a specific implementation of the method 300. Remote UE shown in FIG. 6 is the second terminal device in the foregoing method 300, and relay UE is the first terminal device in the foregoing method 300. The following describes steps included in the method 600.
S610: The relay UE obtains first information from PCF #1.

PCF #1 provides a service for the relay UE. For descriptions of the first information, refer to the foregoing S310. For descriptions of how the relay UE obtains the first information from PCF #1, refer to the following method 800.
S620: The remote UE obtains second information from PCF #2.
PCF #2 provides a service for the remote UE. For descriptions of the second information, refer to the foregoing S320. For descriptions of how the remote UE obtains the second information from PCF #2, refer to the following method 800.
PCF #1 and PCF #2 are a same PCF network element, or is different PCF network elements. In response to the remote UE and the relay UE having a same home PLMN, PCF #1 and PCF #2 are a same PCF network element. In response to the remote UE and the relay UE having different home PLMNs, PCF #1 and PCF #2 are different PCF network elements.
S630: The relay UE sends a discovery announce message (an example of the first message) to the remote UE.

In response to the relay UE determining, based on the first information, that a first PC5 key is obtained in a control plane manner and a user plane manner, the relay UE determines, depending on whether a preset condition is met, whether to obtain the first PC5 key in the control plane manner. In response to the preset condition being met, the relay UE determines to obtain the first PC5 key in the control plane manner: or in response to none of the preset conditions being met, the relay UE obtains the first PC5 key in the control plane manner or the user plane manner. The first PC5 key is a key used for a PC5 link between the remote UE and the relay UE. For descriptions of the manner in which the relay UE determines, based on the first information, to obtain the first PC5 key, refer to the foregoing S310. That the preset condition is met means that at least one of the preset conditions is met.

The preset condition includes: a first RSC used by the relay UE in a proximity direct discovery procedure corresponds to a layer-2 UE-to-network relay communication service.

Further, in response to the relay UE determining to obtain the first PC5 key in the control plane manner, the discovery announce message sent to the remote UE includes first indication information, and the first indication information indicates to obtain the first PC5 key in the control plane manner. For more descriptions of the first indication information, refer to the foregoing S310.

The discovery request message is a discovery announcing message sent by announcing (announcing) UE in a Model A discovery model.
S540: The remote UE sends a direct communication request message (an example of the response message of the first message) to the relay UE.

In response to the remote UE determining, based on the discovery announce message, that the relay UE provides a first relay service used by the remote UE, and the remote UE determines, based on the second information, that the first PC5 key is obtained in the control plane manner, the remote UE sends the direct communication request message to the relay UE.

In response to the remote UE determining, based on the discovery announce message, that the relay UE provides a first relay service used by the remote UE, but the remote UE determines, based on the second information, that the first PC5 key cannot be obtained in the control plane manner, the remote UE does not send the direct communication request message to the relay UE.

For descriptions of the manner in which the remote UE determines, based on the second information, to obtain the first PC5 key, refer to the foregoing S320.

The direct communication request message is a DCR message for initiating establishment of the PC5 link.
S650: The remote UE and the relay UE continue to perform the PC5 link establishment procedure.

In response to the remote UE sending the direct communication request message to the relay UE, the remote UE and the relay UE continue to perform the PC5 link establishment procedure.

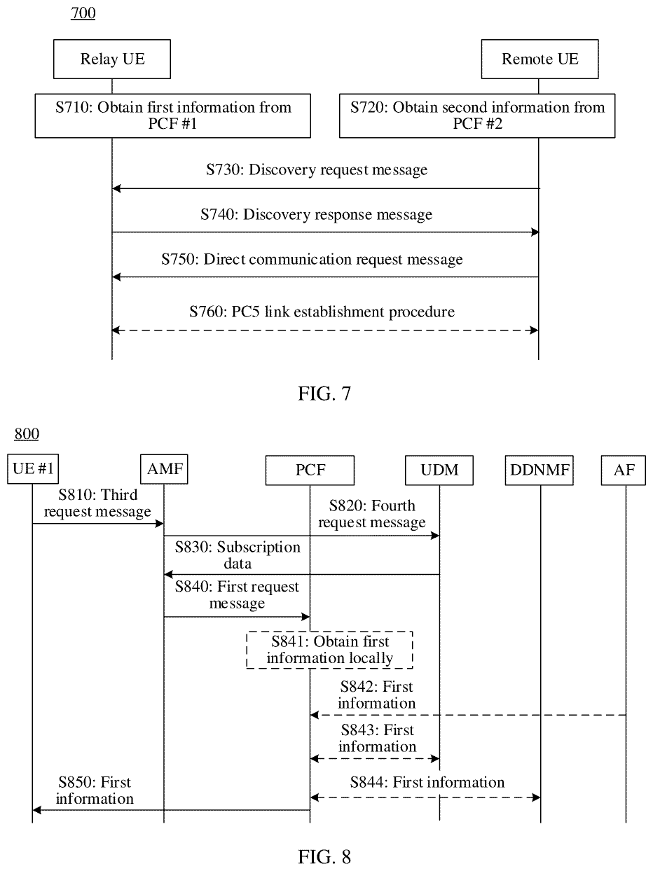

FIG. 7 is a schematic flowchart of a method for determining a key obtaining manner according to at least one embodiment. A method 700 shown in FIG. 7 is a specific implementation of the method 300. Remote UE shown in FIG. 7 is the second terminal device in the foregoing method 300, and relay UE is the first terminal device in the foregoing method 300. The following describes steps included in the method 700.
S710 and S720 are the same as S610 and S620 in the method 600.
S730: The remote UE sends a discovery request message (an example of the third message) to the relay UE.

The discovery request message includes a second RSC used by the remote UE in a proximity direct discovery procedure. Optionally, the discovery request message further includes a second PLMN ID of a home network of the remote UE.

The discovery request message is a discovery request message sent by discoverer (discoverer) UE in a Model B discovery model.
S740: The relay UE sends a discovery response message (an example of the first message) to the remote UE.

In response to the relay UE determining, based on the discovery request message, that the relay UE provides a first relay service for the remote UE, the relay UE sends the discovery response message to the remote UE.

Before the relay UE sends the discovery response message to the remote UE, in response to the relay UE determining, based on the first information, that a first PC5 key is obtained in a control plane manner and a user plane manner, the relay UE determines, depending on whether a preset condition is met, whether to obtain the first PC5 key in the control plane manner. In response to the preset condition being met, the relay UE determines to obtain the first PC5 key in the control plane manner: or in response to none of the preset conditions being met, the relay UE determines to obtain the first PC5 key in the control plane manner or the user plane manner. The first PC5 key is a key used for a PC5 link between the remote UE and the relay UE. For descriptions of the manner in which the relay UE determines, based on the first information, to obtain the first PC5 key, refer to the foregoing S310. That the preset condition is met means that at least one of the preset conditions is met.

The preset condition includes one or more of the following: a first RSC used by the relay UE in a proximity direct discovery procedure corresponds to a layer-2 UE-to-network relay communication service, and the second RSC corresponds to the layer-2 UE-to-network relay communication service.

Optionally, in response to the discovery request message including the second PLMN ID, the relay UE further determines, depending on whether a first PLMN ID of a home network of the relay UE is consistent with the second PLMN ID, whether to obtain the first PC5 key in the control plane manner.

Further, in response to the relay UE determining to obtain the first PC5 key in the control plane manner, the discovery response message sent to the remote UE includes first indication information, and the first indication information indicates to obtain the first PC5 key in the control plane manner. For more descriptions of the first indication information, refer to the foregoing S310.

The discovery response message is a discovery request message sent by discoveree (discoveree) UE in the Model B discovery model.
S750: The remote UE sends a direct communication request message (an example of the response message of the first message) to the relay UE.

In response to the remote UE determining, based on the second information, that the first PC5 key is obtained in the control plane manner, the remote UE sends the direct communication request message to the relay UE.

In response to the remote UE determining, based on the second information, that the first PC5 key cannot be obtained in the control plane manner, the remote UE does not send the direct communication request message to the relay UE.

For descriptions of the manner in which the remote UE determines, based on the second information, to obtain the first PC5 key, refer to the foregoing S320.

The direct communication request is a DCR message for initiating establishment of the PC5 link.
S760: The remote UE and the relay UE continue to perform the PC5 link establishment procedure.

In response to the remote UE sending the direct communication request message to the relay UE, the remote UE and the relay UE continue to perform the PC5 link establishment procedure.

With reference to FIG. 8, the following describes a manner in which the first terminal device obtains the first information from the PCF in the foregoing S310. A manner in which the second terminal device obtains the second information from the PCF in the foregoing S320 is the same as the manner in which the first terminal device obtains the first information. For brevity, details are not described again in at least one embodiment.

FIG. 8 is a schematic flowchart of a communication method according to at least one embodiment. As shown in FIG. 8, the method 800 includes S810 to S850. The following describes the steps in detail.
S810: A first terminal device (denoted as UE #1) sends a third request message to an access and mobility management network element (denoted as an AMF).

The third request message is for requesting proximity-based service policy configuration, the third request message includes relay capability information of UE #1, and the relay capability information indicates that UE #1 supports use of a UE-to-network relay communication service. For example, the third request message is a 5G ProSe policy configuration request (5G ProSe provisioning request) message, and the 5G ProSe policy configuration request message includes a 5G ProSe UE-to-network relay communication capability.

UE #1 supports use of the UE-to-network relay communication service is specifically UE #1 having a capability of supporting use of the UE-to-network relay communication service or a capability of providing a network relay service for the UE-to-network relay communication service.

Optionally, in response to UE #1 locally storing first information, UE #1 carries the first information in the third request message. The first information indicates to obtain a PC5 key in a control plane manner and/or a user plane manner, or the first information includes one or more of the following: a first mapping relationship and a second mapping relationship.

Optionally, a service provider of the relay service alternatively pre-configures the first information in UE #1 by using a carrier of a home network of UE #1.

Optionally, an AS or an AF of the relay service alternatively pre-configures the first information in UE #1 by using the user plane.

In at least one embodiment, the first mapping relationship includes one or more of the following mapping relationships: a mapping relationship between second indication information and a first PLMN ID, a mapping relationship between the second indication information and a second PLMN ID, a mapping relationship between fifth indication information and the first PLMN ID, and a mapping relationship between the fifth indication information and the second PLMN ID. The first PLMN ID is a PLMN ID of the home network of UE #1, and the second PLMN ID is a PLMN ID of a home network of a second terminal device (denoted as UE #2). The second mapping relationship includes a mapping relationship between the second indication information or the fifth indication information and identifier information of the relay service. The second indication information indicates to obtain the PC5 key in the control plane manner and the user plane manner, and the fifth indication information indicates to obtain the PC5 key in the control plane manner or the user plane manner.

The first mapping relationship indicates a mapping relationship between the second indication information or the fifth indication information and the PLMN in which the terminal is located, and the first mapping relationship further indicates a mapping relationship between the second indication information or the fifth indication information and a PLMN in which a key management network element is located.
S820: The AMF sends a fourth request message to a unified data management network element (denoted as a UDM).

The fourth request message is for requesting subscription data of UE #1. For example, the subscription data of the UE #1 is ProSe subscription information, and the ProSe subscription information is for determining that UE #1 uses the UE-to-network relay communication service, or the ProSe subscription information is for determining that UE #1 provides a network relay service for the UE-to-network relay communication service.
S830: The AMF receives the subscription data from the UDM.

Optionally, the AMF further receives the first information from the UDM. For descriptions of the first information, refer to the foregoing S310. For brevity, details are not described herein.

In response to the AMF further receiving the first information from the UDM, the UDM stores the first information, and the first information indicates to obtain the PC5 key in the control plane manner and/or the user plane manner, or the first information includes one or more of the following: the first mapping relationship and the second mapping relationship. In response to the first information indicating to obtain the PC5 key in the control plane manner and/or the user plane manner, the first information stored in the UDM is preconfigured by the carrier of the home network of UE #1. In response to the first information including the first mapping relationship, the carrier of the home network of UE #1 preconfigures a correspondence between indication information and a PLMN ID in the UDM, and the correspondence between the indication information and the PLMN ID is a correspondence between the PLMN ID and indication information that indicates the manner of obtaining the PC5 key and that is in all PLMNs that have a roaming agreement with the carrier of the home network of UE #1: in response to the first information including the second mapping relationship, service providers of different relay services pre-configure correspondences between the indication information and identifier information of the relay services in the UDM of the home PLMN of UE #1 by using the carrier of the home network of UE #1.

Optionally, the service provider of the relay service configures, in the UDM of the home PLMN of UE #1 by using the carrier of the home network of the UE #1, the first mapping relationship or the first information that indicates to obtain the PC5 key in the control plane manner and/or the user plane manner.

Optionally, the carrier of the home network of UE #1 alternatively pre-configures the second mapping relationship in the UDM of the home PLMN of UE #1.

In response to UE #2 performing this procedure, the UDM stores second information, and the second information indicates to obtain the PC5 key in the control plane manner and/or the user plane manner, or the second information includes one or more of the following: third mapping relationship and fourth mapping relationship. In at least one embodiment, the third mapping relationship includes one or more of the following mapping relationships: a mapping relationship between third indication information and the first PLMN ID, a mapping relationship between the third indication information and the second PLMN ID, a mapping relationship between sixth indication information and the first PLMN ID, and a mapping relationship between the sixth indication information and the second PLMN ID. The first PLMN ID is the PLMN ID of the home network of UE #1, and the second PLMN ID is the PLMN ID of the home network of UE #2. The fourth mapping relationship includes a mapping relationship between the third indication information or the sixth indication information and the identifier information of the relay service. The third mapping relationship indicates a mapping relationship between the third indication information or the sixth indication information and the PLMN in which the terminal is located, and the third mapping relationship further indicates a mapping relationship between the third indication information or the sixth indication information and the PLMN in which the key management network element is located. The third indication information indicates to obtain the PC5 key in the control plane manner and/or the user plane manner, and the sixth indication information indicates to obtain the PC5 key in the control plane manner or the user plane manner. For a specific step in which UE #2, the AMF, the PCF, and the UDM obtain the second information, refer to descriptions in which UE #1, the AMF, the PCF, and the UDM obtain the first information. Details are not described again.
S840: The AMF sends a first request message to a policy control function network element (denoted as a PCF).

The first request message is for requesting a ProSe parameter of UE #1, and the ProSe parameter includes a ProSe discovery parameter and a PC5 communication parameter that are related to UE-to-network relay communication.

Specifically, after receiving the subscription data from the UDM, in response to the AMF determining, based on the relay capability information of UE #1 and the subscription data of UE #1 that are included in the third request message, that UE #1 uses the UE-to-network relay communication service or provides the network relay service for the UE-to-network relay communication service, the AMF sends the first request message to the PCF based on the received third request message.

Optionally, the first request message further includes the relay capability information of UE #1.

Optionally, in response to the AMF obtaining the first information from the UDM, the first request message further includes the first information.

Optionally, in response to the UE #1 carrying the first information in the third request message, the AMF carries the first information in the first request message.

Optionally, the AMF does not obtain the first information from the UDM, but locally obtains the first information. In response to the first information indicating to obtain the PC5 key in the control plane manner and/or the user plane manner, the first information locally stored in the AMF is preconfigured by the carrier of the home network of UE #1. In response to the first information including the first mapping relationship, the carrier of the home network of UE #1 preconfigures a correspondence between indication information and a PLMN ID in the AMF, and the correspondence between the indication information and the PLMN ID is a correspondence between the PLMN ID and indication information that indicates the manner of obtaining the PC5 key and that is in all PLMNs that have a roaming agreement with the carrier of the home network of UE #1: in response to the first information including the second mapping relationship, service providers of different relay services pre-configure correspondences between the indication information and identifier information of the relay services in the AMF of the home PLMN of UE #1 by using the carrier of the home network of UE #1.
S850: The PCF sends the ProSe parameter to UE #1.

The ProSe parameter includes the first information. The ProSe parameter further includes RSC information used by UE #1 in the proximity direct discovery procedure and another parameter used in the proximity direct discovery procedure.

In at least one embodiment, once receiving the first request message from the AMF, the PCF determines that UE #1 uses the UE-to-network relay communication service, or determine that UE #1 provides the network relay service for the UE-to-network relay communication service. Further, the PCF carries the first information in the ProSe parameter and sends the ProSe parameter to UE #1.

In at least one embodiment, in response to the first request message including the relay capability information of UE #1, the PCF determines, based on the relay capability information of UE #1, that UE #1 uses the UE-to-network relay communication service, or determines that UE #1 provides the network relay service for the UE-to-network relay communication service. Further, the PCF carries the first information in the ProSe parameter and sends the ProSe parameter to UE #1.

A manner in which the PCF obtains the first information is not limited in at least one embodiment.

In an example, the PCF obtains the first information from the AMF. As described above, in response to the AMF obtaining the subscription data of UE #1 from the UDM, in response to the UDM preconfiguring the first information, the UDM sends the first information to the AMF. Further, the AMF carries the first information in the first request message and sends the first request message to the PCF.

Optionally, in response to the AMF carrying the first information in the first request message, the PCF obtains the first information from the first request message, and determines third information based on the first information. The third information is one of the following: obtaining the PC5 key in the control plane manner or obtaining the PC5 key in the user plane manner.

In another example, the method 800 further includes S841: The PCF obtains the first information locally. In response to the first information indicating to obtain the PC5 key in the control plane manner and/or the user plane manner, the first information locally stored in the PCF is preconfigured by the carrier of the home network of UE #1. In response to the first information including the first mapping relationship, the carrier of the home network of UE #1 preconfigures a correspondence between indication information and a PLMN ID in the PCF, and the correspondence between the indication information and the PLMN ID is a correspondence between the PLMN ID and indication information that indicates the manner of obtaining the PC5 key and that is in all PLMNs that have a roaming agreement with the carrier of the home network of UE #1: in response to the first information including the second mapping relationship, service providers of different relay services pre-configure correspondences between the indication information and identifier information of the relay services in the PCF of the home PLMN of UE #1 by using the carrier of the home network of UE #1.

Optionally, in response to the first information including the second mapping relationship, the method 800 further includes S842: The AF sends the first information to the PCF. Specifically, in S842, AFs corresponding to different relay services send correspondences between identifier information of the relay services and indication information to the PCF at any time by using an NEF network element. Correspondingly, after receiving the correspondence between the indication information and the identifier information of the relay service from the AF, the PCF locally stores the correspondence.

Optionally, the service provider of the relay service or the AF configures, in the PCF of the home PLMN of UE #1 by using the carrier of the home network of the UE #1, the first mapping relationship or the first information that indicates to obtain the PC5 key in the control plane manner and/or the user plane manner.

In still another example, the method 800 further includes S843: The PCF obtains the first information from the UDM. Specifically, in S843, the PCF sends a second request message to the UDM, where the second request message is for requesting the first information. Correspondingly, the UDM sends the first information to the PCF based on the second request message.

In yet another example, the method 800 further includes S844: The PCF obtains the first information from a DDNMF. Specifically, in S844, the PCF sends a second request message to the DDNMF, where the second request message is for requesting the first information. Correspondingly, the DDNMF sends the first information to the PCF based on the second request message.

In response to the PCF receiving the first information from the DDNMF, the DDNMF stores the first information, and the first information indicates to obtain the PC5 key in the control plane manner and/or the user plane manner, or the first information includes one or more of the following: the first mapping relationship and the second mapping relationship. In response to the first information indicating to obtain the PC5 key in the control plane manner and/or the user plane manner, the first information locally stored in the DDNMF is preconfigured by the carrier of the home network of UE #1. In response to the first information including the first mapping relationship, the carrier of the home network of UE #1 preconfigures a correspondence between indication information and a PLMN ID in the DDNMF, and the correspondence between the indication information and the PLMN ID is a correspondence between the PLMN ID and indication information that indicates the manner of obtaining the PC5 key and that is in all PLMNs that have a roaming agreement with the carrier of the home network of UE #1: in response to the first information including the second mapping relationship, service providers of different relay services pre-configure correspondences between the indication information and identifier information of the relay services in the DDNMF by using the carrier of the home network of UE #1.

Optionally, in response to the first information including the second mapping relationship, and the DDNMF does not locally pre-configure the first information, the DDNMF obtains, from servers of different relay services by using the user plane, indication information corresponding to identifier information of the different relay services, and locally store a correspondence between the relay service identifier information and the indication information.

Optionally, the service provider of the relay service configures, in the DDNMF of the home PLMN of UE #1 by using the carrier of the home network of the UE #1, the first mapping relationship or the first information that indicates to obtain the PC5 key in the control plane manner and/or the user plane manner.

In S850, the PCF sends the ProSe parameter to the AMF, and then the AMF forwards the ProSe parameter to UE #1.

Optionally, in response to the AMF obtaining the first information from the UDM, and the ProSe parameter received by the AMF from the PCF does not include the first information, the AMF sends the first information and the ProSe parameter to UE #1.

Optionally, in response to the PCF determining the third information in S850, the PCF sends the third information to UE #1 by using the AMF, and UE #1 directly determines, by using the third information, the manner of obtaining the first PC5 key.

In at least one embodiment, in response to UE #1 using the UE-to-network relay communication service, or providing the network relay service for the UE-to-network relay communication service, UE #1 obtains, from the network side (the PCF or the AMF), the first information for determining the first PC5 key, so that UE #1 determines, based on the first information, the manner of obtaining the first PC5 key. This helps UE #1 successfully establish the PC5 link.

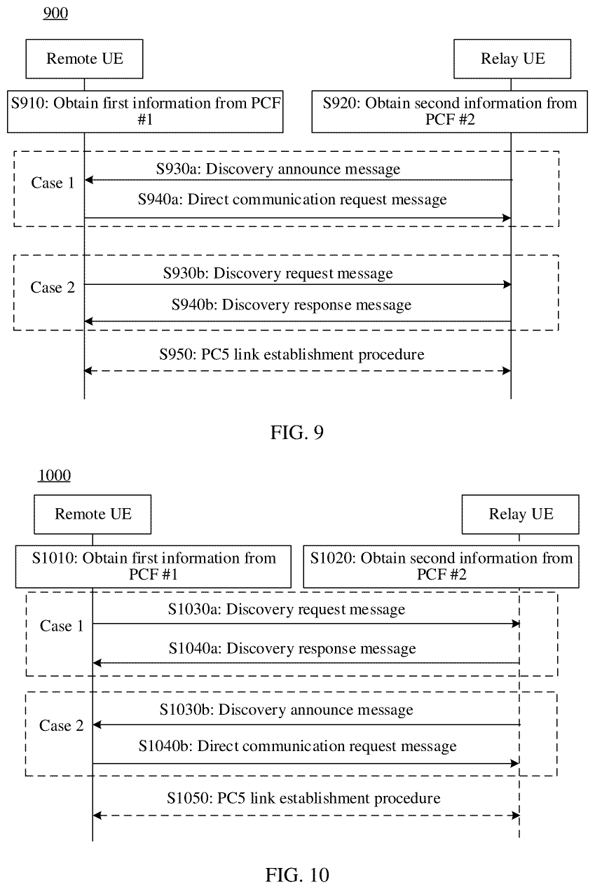

The foregoing embodiment describes how to determine the manner of obtaining the first PC5 key in response to the remote UE obtaining the first PC5 key in the control plane manner and the user plane manner, and further describing how to determine the manner of obtaining the first PC5 key in response to the relay UE obtaining the first PC5 key in the control plane manner and the user plane manner. With reference to FIG. 9, the following describes how relay UE negotiates with remote UE to obtain a first PC5 key in response to the relay UE obtaining the first PC5 key only in a control plane manner or only in a user plane manner. With reference to FIG. 10, the following describes how remote UE negotiates with relay UE to obtain a first PC5 key in response to the remote UE obtaining the first PC5 key only in a control plane manner or only in a user plane manner.

FIG. 9 is a schematic flowchart of determining a key obtaining manner according to at least one embodiment. As shown in FIG. 9, the method 900 includes S910 to S950. The following describes the steps in detail.
S910: Remote UE obtains first information from PCF #1.

PCF #1 provides a service for the remote UE.

For example, the first information indicates to obtain a PC5 key in a control plane manner or a user plane manner. The first information corresponds to a PLMN ID of a home network of the remote UE, but the first information does not indicate a correspondence between the first information and the PLMN ID of the home network of the remote UE, that is, the first information does not include identifier information that indicates the PLMN ID of the home network of the remote UE. For example, the first information is indication information obtained by a network element and/or UE in a PLMN corresponding to the PLMN ID of the home network of the remote UE.

For another example, the first information includes a first mapping relationship, the first mapping relationship includes a correspondence between at least one piece of indication information and at least one PLMN ID, each of the at least one piece of indication information indicates to obtain the PC5 key in the control plane manner and/or the control plane manner, and the at least one PLMN ID includes the PLMN ID of the home network of the remote UE and/or a PLMN ID of a home network of relay UE.

The first mapping relationship indicates a correspondence between at least one piece of indication information and the PLMN in which the terminal is located, and the first mapping relationship further indicates a correspondence between the at least one piece of indication information and a PLMN in which a key management network element is located.

For still another example, the second information includes a fourth mapping relationship, the fourth mapping relationship includes a correspondence between at least one piece of indication information and identifier information of at least one relay service, each of the at least one piece of indication information indicates to obtain the PC5 key in the control plane manner and/or the user plane manner, the at least one relay service includes a first relay service, and the first relay service corresponds to a PC5 link between the first terminal device and the second terminal device, that is, the PC5 link is established for the first relay service.
S920: The relay UE obtains second information from PCF #2.

PCF #2 provides a service for the relay UE.

For example, the second information indicates to obtain the PC5 key in the control plane manner or the user plane manner. The second information corresponds to the PLMN ID of the home network of the relay UE, but the second information does not indicate a correspondence between the second information and the PLMN ID of the home network of the relay UE, that is, the second information does not include identifier information that indicates the PLMN ID of the home network of the relay UE. For example, the second information is indication information obtained by a network element and/or UE in a PLMN corresponding to the PLMN ID of the home network of the relay UE.

For another example, the second information includes a third mapping relationship, the third mapping relationship includes a correspondence between at least one piece of indication information and at least one PLMN ID, each of the at least one piece of indication information indicates to obtain the PC5 key in the control plane manner and/or the user plane manner, and the at least one PLMN ID includes the PLMN ID of the home network of the remote UE and/or the PLMN ID of the home network of the relay UE.

The third mapping relationship indicates a correspondence between at least one piece of indication information and the PLMN in which the terminal is located, and the third mapping relationship further indicates a correspondence between the at least one piece of indication information and a PLMN in which a key management network element is located.

For still another example, the second information includes a fourth mapping relationship, the fourth mapping relationship includes a correspondence between at least one piece of indication information and identifier information of at least one relay service, each of the at least one piece of indication information indicates to obtain the PC5 key in the control plane manner and/or the user plane manner, the at least one relay service includes a first relay service, and the first relay service corresponds to the PC5 link between the first terminal device and the second terminal device, that is, the PC5 link is established for the first relay service.

PCF #1 and PCF #2 are a same PCF network element, or are different PCF network elements. In response to the remote UE and the relay UE having a same home PLMN, PCF #1 and PCF #2 are a same PCF network element. In response to the remote UE and the relay UE having different home PLMNs, PCF #1 and PCF #2 are different PCF network elements.

Case 1: In the method 900, S930a and S940a are performed.
S930a: The relay UE sends a discovery announce message to the remote UE.

The discovery announce message includes seventh indication information, and the seventh indication information indicates, to the remote UE, a manner that is determined by the relay UE and that is of obtaining a first PC5 key.

Specifically, the relay UE determines, based on the second information, the manner of obtaining the first PC5 key.

In an example, in response to the second information indicating to obtain the PC5 key in the control plane manner or the user plane manner, the relay UE determines, based on the second information, the manner of obtaining the first PC5 key. For example, in response to the second information indicating to obtain the PC5 key in the control plane manner, the relay UE determines to obtain the first PC5 key in the control plane manner: or in response to the second information indicating to obtain the PC5 key in the user plane manner, the relay UE determines to obtain the first PC5 key in the user plane manner.

In another example, in response to the second information including the third mapping relationship, the relay UE determines, based on sixth indication information, the manner of obtaining the first PC5 key, where the sixth indication information indicates to obtain the PC5 key in the control plane manner or the user plane manner, and the sixth indication information is corresponding to the PLMN ID of the home network of the remote UE or the PLMN ID of the home network of the relay UE.

In another example, in response to the second information including the fourth mapping relationship, the relay UE determines, based on sixth indication information, the manner of obtaining the first PC5 key, where the sixth indication information indicates to obtain the PC5 key in the control plane manner or the user plane manner, and the sixth indication information is corresponding to the first relay service related to the RSC in the discovery announce message.

A specific form of the seventh indication information is not limited in at least one embodiment.

In an example, the seventh indication information is equivalent to the sixth indication information or the second information, that is, the relay UE carries the sixth indication information or the second information in the discovery announce message and sends the discovery announce message to the remote UE. The second information indicates to obtain the PC5 key in the control plane manner or the user plane manner.

In an example, the relay UE determines, based on the second information, the manner of obtaining the first PC5 key, and determines the seventh indication information based on the manner of obtaining the first PC5 key. To be specific, in response to obtaining the first PC5 key in the control plane manner, the seventh indication information is obtaining the PC5 key in the control plane manner: or in response to obtaining the first PC5 key in the user plane manner, the seventh indication information is obtaining the PC5 key in the user plane manner.

In another example, the seventh indication information is a PLMN ID corresponding to the sixth indication information. For example, in response to the sixth indication information corresponding to the PLMN ID of the home network of the remote UE, the seventh indication information is the PLMN ID of the home network of the remote UE: or in response to the sixth indication information corresponding to the PLMN ID of the home network of the relay UE, the seventh indication information is the PLMN ID of the home network of the relay UE.

In another example, the seventh indication information is identifier information of a first relay service corresponding to the sixth indication information. For example, in response to the sixth indication information corresponds to the first relay service, the seventh indication information is identifier information of the first relay service, and the identifier information is an RSC or ID information of the first relay service.

In an example, in response to the seventh indication information obtaining the PC5 key in the control plane manner, the seventh indication information is represented by 00: or in response to the seventh indication information obtaining the PC5 key in the user plane manner, the seventh indication information is represented by 01. This is not limited in at least one embodiment.

The discovery announce message is a discovery announcing message in a model A discovery procedure.
S940a: The remote UE sends a direct communication request message to the relay UE.

In response to the manner being determined by the remote UE and that is of obtaining the first PC5 key is the same as the manner that is determined by the relay UE and that is of obtaining the first PC5 key, the remote UE sends the direct communication request message to the relay UE.

In response to the manner being determined by the remote UE and that is of obtaining the first PC5 key is different from the manner that is determined by the relay UE and that is of obtaining the first PC5 key, the remote UE does not send the direct communication request message to the relay UE.

Specifically, the remote UE determines, based on the first information and the seventh indication information, whether the manners that are separately determined by the remote UE and the relay UE and that are of obtaining the first PC5 key are the same.

In an example, in response to the first information indicating to obtain the PC5 key in the control plane manner or the user plane manner, and the seventh indication information being equivalent to the sixth indication information or the second information, the remote UE determines, depending on whether the first information and the seventh indication information are the same, whether the manners that are separately determined by the remote UE and the relay UE and that are of obtaining the first PC5 key are the same. In response to the first information and the seventh indication information being the same, the remote UE determines that the manners that are separately determined by the remote UE and the relay UE and that are of obtaining the first PC5 key are the same: or in response to the first information and the seventh indication information being different, the remote UE determines that the manners that are separately determined by the remote UE and the relay UE and that are of obtaining the first PC5 key are different.

In response to the first information indicating to obtain the PC5 key in the control plane manner or the user plane manner, and the seventh indication information indicating to obtain the PC5 key in the control plane manner or the user plane manner, the remote UE determines, based on the first information, the manner of obtaining the PC5 key, and determine, through comparison, whether the manner determined based on the first information and the manner indicated by the seventh indication information are the same. In response to the PC5 key obtaining manner determined based on the first information and the PC5 key obtaining manner indicated by the seventh indication information being the same, the remote UE determines that the manners that are separately determined by the remote UE and the relay UE and that are of obtaining the first PC5 key are the same: or in response to the PC5 key obtaining manner determined based on the first information and the PC5 key obtaining manner indicated by the seventh indication information being different, the remote UE determines that the manners that are separately determined by the remote UE and the relay UE and that are of obtaining the first PC5 key are different.

In another example, in response to the first information including the first mapping relationship, and the seventh indication information being equivalent to the sixth indication information or the second information, the remote UE determines, depending on whether fifth indication information and the seventh indication information are the same, whether the manners that are separately determined by the remote UE and the relay UE and that are of obtaining the first PC5 key are the same. The fifth indication information indicates to obtain the PC5 key in the control plane manner or the user plane manner, and the fifth indication information is corresponding to the PLMN ID of the home network of the remote UE or the PLMN ID of the home network of the relay UE.

In response to the first information including the first mapping relationship, and the seventh indication information indicating to obtain the PC5 key in the control plane manner or the user plane manner, the remote UE determines, based on the fifth indication information, the manner of obtaining the PC5 key, and determine, through comparison, whether the manner determined based on the fifth indication information and the manner indicated by the seventh indication information are the same. In response to the PC5 key obtaining manner determined based on the fifth indication information and the PC5 key obtaining manner indicated by the seventh indication information being the same, the remote UE determines that the manners that are separately determined by the remote UE and the relay UE and that are of obtaining the first PC5 key are the same: or in response to the PC5 key obtaining manner determined based on the fifth indication information and the PC5 key obtaining manner indicated by the seventh indication information being different, the remote UE determines that the manners that are separately determined by the remote UE and the relay UE and that are of obtaining the first PC5 key are different.

In another example, in response to the first information including second mapping relationship, and the seventh indication information being equivalent to the sixth indication information or the second information, the remote UE determines, depending on whether fifth indication information and the seventh indication information are the same, whether the manners that are separately determined by the remote UE and the relay UE and that are of obtaining the first PC5 key are the same. The fifth indication information indicates to obtain the PC5 key in the control plane manner or the user plane manner, and the fifth indication information is corresponding to the identifier information of the first relay service.

In response to the first information including the second mapping relationship, and the seventh indication information indicating to obtain the PC5 key in the control plane manner or the user plane manner, the remote UE determines, based on the fifth indication information, the manner of obtaining the PC5 key, and determine, through comparison, whether the manner determined based on the fifth indication information and the manner indicated by the seventh indication information are the same. In response to the PC5 key obtaining manner determined based on the fifth indication information and the PC5 key obtaining manner indicated by the seventh indication information being the same, the remote UE determines that the manners that are separately determined by the remote UE and the relay UE and that are of obtaining the first PC5 key are the same: or in response to the PC5 key obtaining manner determined based on the fifth indication information and the PC5 key obtaining manner indicated by the seventh indication information being different, the remote UE determines that the manners that are separately determined by the remote UE and the relay UE and that are of obtaining the first PC5 key are different.

In still another example, in response to the first information including the first mapping relationship, and the seventh indication information being a PLMN ID, the remote UE determines, based on the seventh indication information and the first mapping relationship, the manner of obtaining the PC5 key, and determines, depending on whether the manner of obtaining the PC5 key and the manner indicated by the fifth indication information are the same, whether the manners of obtaining the first PC5 key that are separately determined by the remote UE and the relay UE are the same. In response to the manner that is of obtaining the PC5 key and that is determined by the remote UE based on the seventh indication information and the first mapping relationship being the same as the manner that is of obtaining the PC5 key and that is indicated by the fifth indication information, the manners obtaining the first PC5 key by the remote UE and the relay UE are the same: otherwise, the manners of obtaining the first PC5 key by the remote UE and the relay UE are different. The manner that is of obtaining the PC5 key and that is determined by the remote UE based on the seventh indication information and the first mapping relationship is a manner indicated by indication information corresponding to the seventh indication information in the first mapping relationship.

In yet another example, in response to the first information including the second mapping relationship, and the seventh indication information being the identifier information of the first relay service, the remote UE determines, based on the seventh indication information and the second mapping relationship, the manner of obtaining the PC5 key, and determines, depending on whether the manner of obtaining the PC5 key and the manner indicated by the fifth indication information are the same, whether the manners of obtaining the first PC5 key that are separately determined by the remote UE and the relay UE are the same. In response to the manner that is of obtaining the PC5 key and that is determined by the remote UE based on the seventh indication information and the second mapping relationship being the same as the manner that is of obtaining the PC5 key and that is indicated by the fifth indication information, the manners obtaining the first PC5 key by the remote UE and the relay UE are the same: otherwise, the manners of obtaining the first PC5 key by the remote UE and the relay UE are different. The manner that is of obtaining the PC5 key and that is determined by the remote UE based on the seventh indication information and the second mapping relationship is a manner indicated by indication information corresponding to the seventh indication information in the second mapping relationship.

Case 2: In the method 900, S930b and S940b are performed.
S930b: The remote UE sends a discovery request message to the relay UE.

The discovery request message is a discovery request message sent by discoverer (discoverer) UE in a Model B discovery model.
S940b: The relay UE sends a discovery response message to the remote UE.

In response to the relay UE determining, based on the discovery request message, that the relay UE provides a first relay service for the remote UE, the relay UE sends the discovery response message to the remote UE. The discovery response message includes seventh indication information, and the seventh indication information indicates, to the remote UE, a manner that is determined by the relay UE and that is of obtaining a first PC5 key. For more descriptions about how the relay UE determines the manner of obtaining the first PC5 key and about the seventh indication information, refer to S930a.

The discovery response message is a discovery response message in a model B discovery procedure.
S950: The remote UE and the relay UE continue to perform the PC5 link establishment procedure.

In response to S930a and S940a being performed in the method 900, in S940a, the remote UE sends the direct communication request message to the relay UE, the remote UE and the relay UE continue to perform the PC5 link establishment procedure.

In response to S930b and S940b being performed in the method 900, after the remote UE receives the discovery response message, in response to the remote UE determining, based on the first information and the seventh indication information, manners that are separately determined by the remote UE and the relay UE and that are of obtaining the first PC5 key being the same, the remote UE and the relay UE perform the PC5 link establishment procedure. For how the remote UE determines, based on the first information and the seventh indication information, whether the manners that are separately determined by the remote UE and the relay UE and that are of obtaining the first PC5 key are the same, refer to the descriptions in the foregoing S940a.

In at least one embodiment, the relay UE carries the seventh indication information in the discovery announce or discovery response message, so that the remote UE determines, based on the seventh indication information, whether the manners that are separately determined by the relay UE and the remote UE and that are of obtaining the first PC5 key are the same. In response to the manners that are separately determined by the relay UE and the remote UE and that are of obtaining the first PC5 key being the same, the remote UE sends the direct communication request message to the relay UE, to avoid a PC5 link establishment failure caused by different manners that are determined by the UEs at two ends and that are of obtaining the first PC5 key. In response to the manners that are separately determined by the relay UE and the remote UE and that are of obtaining the first PC5 key being different, the remote UE does not send the direct communication request message to the relay UE, to reduce signaling.

FIG. 10 is a schematic flowchart of determining a key obtaining manner according to at least one embodiment. As shown in FIG. 10, the method 1000 includes S1010 to S1050. The following describes the steps in detail.
S1010 and S1020 are the same as S910 and S920 in the method 900.

Case 1: In the method 1000, S1030a and S1040a are performed.
S1030a: The remote UE sends a discovery request message to the relay UE.

The discovery request message includes eighth indication information, and the eighth indication information indicates, to the relay UE, a manner that is determined by the remote UE and that is of obtaining a first PC5 key.

Specifically, the remote UE determines, based on the first information, the manner of obtaining the first PC5 key.

In an example, in response to the first information indicating to obtain the PC5 key in the control plane manner or the user plane manner, the remote UE determines, based on the first information, the manner of obtaining the first PC5 key. For example, in response to the first information indicating to obtain the PC5 key in the control plane manner, the remote UE determines to obtain the first PC5 key in the control plane manner: or in response to the first information indicating to obtain the PC5 key in the user plane manner, the remote UE determines to obtain the first PC5 key in the user plane manner.

In another example, in response to the first information including the first mapping relationship, the remote UE determines, based on fifth indication information, the manner of obtaining the first PC5 key, where the fifth indication information indicates to obtain the PC5 key in the control plane manner or the user plane manner, and the fifth indication information is corresponding to the PLMN ID of the home network of the remote UE or the PLMN ID of the home network of the relay UE.

In another example, in response to the first information including the second mapping relationship, the remote UE determines, based on fifth indication information, the manner of obtaining the first PC5 key, where the fifth indication information indicates to obtain the PC5 key in the control plane manner or the user plane manner, and the fifth indication information is corresponding to the first relay service related to the RSC in the discovery request message.

A specific form of the eighth indication information is not limited in at least one embodiment.

In an example, the eighth indication information is equivalent to the fifth indication information or the first information, that is, the remote UE carries the fifth indication information or the first information in the discovery request message and sends the discovery request message to the relay UE. The first information indicates to obtain the PC5 key in the control plane manner or the user plane manner.

In an example, the remote UE determines, based on the first information, the manner of obtaining the first PC5 key, and determines the eighth indication information based on the manner of obtaining the first PC5 key. To be specific, in response to obtaining the first PC5 key in the control plane manner, the eighth indication information is obtaining the PC5 key in the control plane manner: or in response to obtaining the first PC5 key in the user plane manner, the eighth indication information is obtaining the PC5 key in the user plane manner.

In another example, the eighth indication information is a PLMN ID corresponding to the fifth indication information. For example, in response to the fifth indication information corresponding to the PLMN ID of the home network of the remote UE, the eighth indication information is the PLMN ID of the home network of the remote UE: or in response to the fifth indication information corresponding to the PLMN ID of the home network of the relay UE, the eighth indication information is the PLMN ID of the home network of the relay UE.

In another example, the eighth indication information is identifier information of a first relay service corresponding to the fifth indication information. For example, in response to the fifth indication information corresponding to the first relay service, the eighth indication information is the identifier information of the first relay service, and the identifier information is an RSC or ID information of the first relay service.

In an example, in response to the eighth indication information obtaining the PC5 key in the control plane manner, the eighth indication information is represented by 00: or in response to the eighth indication information obtaining the PC5 key in the user plane manner, the eighth indication information is represented by 01. This is not limited in at least one embodiment.

The discovery request message is a discovery request message in a model B discovery procedure.
S1040a: The relay UE sends a discovery response message to the remote UE.

In response to the manner that is determined by the relay UE and that is of obtaining the first PC5 key being the same as the manner that is determined by the remote UE and that is of obtaining the first PC5 key, the relay UE sends the discovery response message to the remote UE.

In response to the manner that is determined by the relay UE and that is of obtaining the first PC5 key being different from the manner that is determined by the remote UE and that is of obtaining the first PC5 key, the relay UE does not send the discovery response message to the remote UE, or sends a reject message to the remote UE.

Specifically, the relay UE determines, based on the second information and the eighth indication information, whether the manners that are separately determined by the remote UE and the relay UE and that are of obtaining the first PC5 key are the same.

In an example, in response to the second information indicating to obtain the PC5 key in the control plane manner or the user plane manner, and the eighth indication information being equivalent to the fifth indication information or the first information, the relay UE determines, depending on whether the second information and the eighth indication information are the same, whether the manners that are separately determined by the remote UE and the relay UE and that are of obtaining the first PC5 key are the same. In response to the second information and the eighth indication information being the same, the relay UE determines that the manners that are separately determined by the remote UE and the relay UE and that are of obtaining the first PC5 key are the same: or in response to the second information and the eighth indication information being different, the relay UE determines that the manners that are separately determined by the remote UE and the relay UE and that are of obtaining the first PC5 key are different.

In response to the second information indicating to obtain the PC5 key in the control plane manner or the user plane manner, and the eighth indication information indicating to obtain the PC5 key in the control plane manner or the user plane manner, the relay UE determines, based on the second information, the manner of obtaining the PC5 key, and determine, through comparison, whether the manner determined based on the second information and the manner indicated by the eighth indication information are the same. In response to the PC5 key obtaining manner determined based on the second information and the PC5 key obtaining manner indicated by the eighth indication information being the same, the relay UE determines that the manners that are separately determined by the remote UE and the relay UE and that are of obtaining the first PC5 key are the same: or in response to the PC5 key obtaining manner determined based on the second information and the PC5 key obtaining manner indicated by the eighth indication information being different, the relay UE determines that the manners that are separately determined by the remote UE and the relay UE and that are of obtaining the first PC5 key are different.

In another example, in response to the second information including third mapping relationship, and the eighth indication information being equivalent to the fifth indication information or the first information, the relay UE determines, depending on whether sixth indication information and the eighth indication information are the same, whether the manners that are separately determined by the remote UE and the relay UE and that are of obtaining the first PC5 key are the same. The sixth indication information indicates to obtain the PC5 key in the control plane manner or the user plane manner, and the sixth indication information is corresponding to the PLMN ID of the home network of the remote UE or the PLMN ID of the home network of the relay UE.

In response to the second information including the third mapping relationship, and the eighth indication information indicating to obtain the PC5 key in the control plane manner or the user plane manner, the relay UE determines, based on the sixth indication information, the manner of obtaining the PC5 key, and determine, through comparison, whether the manner determined based on the sixth indication information and the manner indicated by the eighth indication information are the same. In response to the PC5 key obtaining manner determined based on the sixth indication information and the PC5 key obtaining manner indicated by the eighth indication information being the same, the relay UE determines that the manners that are separately determined by the remote UE and the relay UE and that are of obtaining the first PC5 key are the same: or in response to the PC5 key obtaining manner determined based on the sixth indication information and the PC5 key obtaining manner indicated by the eighth indication information being different, the relay UE determines that the manners that are separately determined by the remote UE and the relay UE and that are of obtaining the first PC5 key are different.

In another example, in response to the second information including fourth mapping relationship, and the eighth indication information being equivalent to the fifth indication information or the first information, the relay UE determines, depending on whether sixth indication information and the eighth indication information are the same, whether the manners that are separately determined by the remote UE and the relay UE and that are of obtaining the first PC5 key are the same. The sixth indication information indicates to obtain the PC5 key in the control plane manner or the user plane manner, and the sixth indication information is corresponding to the identifier information of the first relay service.

In response to the second information including the fourth mapping relationship, and the eighth indication information indicating to obtain the PC5 key in the control plane manner or the user plane manner, the relay UE determines, based on the sixth indication information, the manner of obtaining the PC5 key, and determine, through comparison, whether the manner determined based on the sixth indication information and the manner indicated by the eighth indication information are the same. In response to the PC5 key obtaining manner determined based on the sixth indication information and the PC5 key obtaining manner indicated by the eighth indication information being the same, the relay UE determines that the manners that are separately determined by the remote UE and the relay UE and that are of obtaining the first PC5 key are the same: or in response to the PC5 key obtaining manner determined based on the sixth indication information and the PC5 key obtaining manner indicated by the seventh indication information being different, the remote UE determines that the manners that are separately determined by the remote UE and the relay UE and that are of obtaining the first PC5 key are different.

In still another example, in response to the second information including the third mapping relationship, and the eighth indication information being a PLMN ID, the relay UE determines, based on the eighth indication information and the third mapping relationship, the manner of obtaining the PC5 key, and determines, depending on whether the manner of obtaining the PC5 key and the manner indicated by the sixth indication information are the same, whether the manners of obtaining the first PC5 key that are separately determined by the remote UE and the relay UE are the same. In response to the manner that is of obtaining the PC5 key and that is determined by the relay UE based on the eighth indication information and the third mapping relationship being the same as the manner that is of obtaining the PC5 key and that is indicated by the sixth indication information, the manners obtaining the first PC5 key by the remote UE and the relay UE are the same: otherwise, the manners of obtaining the first PC5 key by the remote UE and the relay UE are different. The manner that is of obtaining the PC5 key and that is determined by the relay UE based on the eighth indication information and the third mapping relationship is a manner indicated by indication information corresponding to the eighth indication information in the third mapping relationship.

In yet another example, in response to the first information including fourth mapping relationship, and the eighth indication information being the identifier information of the first relay service, the relay UE determines, based on the eighth indication information and the fourth mapping relationship, the manner of obtaining the PC5 key, and determines, depending on whether the manner of obtaining the PC5 key and the manner indicated by the sixth indication information are the same, whether the manners of obtaining the first PC5 key that are separately determined by the relay UE and the remote UE are the same. In response to the manner that is of obtaining the PC5 key and that is determined by the relay UE based on the eighth indication information and the fourth mapping relationship being the same as the manner that is of obtaining the PC5 key and that is indicated by the sixth indication information, the manners obtaining the first PC5 key by the relay UE and the remote UE are the same; otherwise, the manners of obtaining the first PC5 key by the relay UE and the remote UE are different. The manner that is of obtaining the PC5 key and that is determined by the relay UE based on the eighth indication information and the second mapping relationship is a manner indicated by indication information corresponding to the eighth indication information in the fourth mapping relationship.

The discovery response message is a discovery response message in a model B discovery procedure.

Case 2: In the method 1000, S1030b and S1040b are performed.
S1030b: The relay UE sends a discovery announce message to the remote UE.

The discovery announce message is a discovery announcing message sent by announcing (announcing) UE in a Model A discovery model.
S1040b: The remote UE sends a direct communication request message to the relay UE.

In response to the remote UE determining, based on the discovery announce message, that the relay UE provides a first relay service used by the remote UE, the remote UE sends the direct communication request message to the remote UE. The direct communication request message includes eighth indication information, and the eighth indication information indicates, to the relay UE, a manner that is determined by the remote UE and that is of obtaining a first PC5 key. For more descriptions about how the remote UE determines the manner of obtaining the first PC5 key and about the eighth indication information, refer to S1030a.

The direct communication message is a DCR message for initiating a PC5 link.
S1050: The remote UE and the relay UE perform the PC5 link establishment procedure.

In response to S1030a and S1040a being performed in the method 1000, in S1040a, the relay UE sends the discovery response message to the source UE, and the remote UE and the relay UE perform the PC5 link establishment procedure.

In response to S1030b and S1040b being performed in the method 1000, after the relay UE receives the direct communication request message, in response to the relay UE determining, based on the second information and the eighth indication information, manners that are separately determined by the remote UE and the relay UE and that are of obtaining the first PC5 key being the same, the relay UE and the remote UE perform the PC5 link establishment procedure: or in response to the relay UE determining the manners that are separately determined by the remote UE and the relay UE and that are of obtaining the first PC5 key being different, the relay UE terminates the PC5 link establishment procedure, or sends a reject message to the remote UE, where the reject message carries cause value information that indicates the manners of obtaining the first PC5 key are different. For how the relay UE determines, based on the second information and the eighth indication information, whether the manners that are separately determined by the remote UE and the relay UE and that are of obtaining the first PC5 key are the same, refer to the descriptions in the foregoing S1040a.

In at least one embodiment, the remote UE carries the eighth indication information in the discovery request message or the direct communication request message, so that the relay UE determines, based on the eighth indication information, whether the manners that are separately determined by the relay UE and the remote UE and that are of obtaining the first PC5 key are the same. In response to the manners that are separately determined by the relay UE and the remote UE and that are of obtaining the first PC5 key being the same, the relay UE sends the discovery response message to the remote UE, to avoid a PC5 link establishment failure caused by different manners that are determined by the UEs at two ends and that are of obtaining the first PC5 key. In response to the manners that are separately determined by the relay UE and the remote UE and that are of obtaining the first PC5 key being different, the relay UE does not send the discovery response message to the remote UE, or sends the reject message to the remote UE, to reduce signaling.

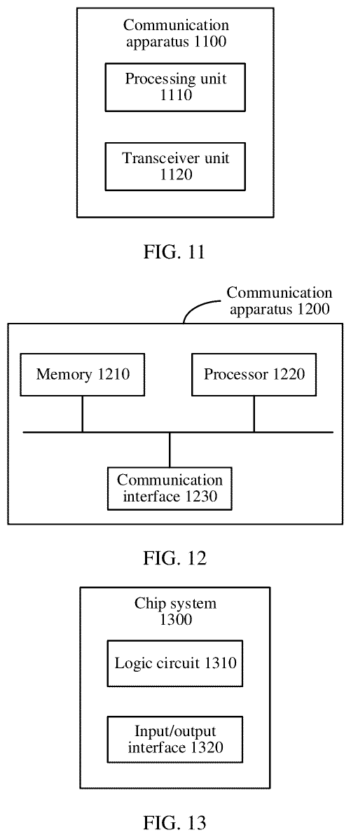

The foregoing describes in detail the methods provided in at least one embodiment with reference to FIG. 3 to FIG. 10. The following describes in detail communication apparatuses provided in at least one embodiment with reference to FIG. 11 and FIG. 13.

FIG. 11 is a schematic block diagram of a communication apparatus according to at least one embodiment. As shown in FIG. 11, a communication apparatus 1100 includes a processing unit 1110 and a transceiver unit 1120.

In at least one embodiment, the communication apparatus 1100 corresponds to the terminal device in the foregoing method embodiments, for example, is a terminal device, or is a component (for example, a chip or a chip system) configured in the terminal device.

The communication apparatus 1100 corresponds to the first terminal device in the method 300 according to at least one embodiment, and the communication apparatus 1100 includes units configured to perform the method performed by the first terminal device in the method 300 in FIG. 3. In addition, units in the communication apparatus 1100 and the foregoing other operations and/or functions are separately used to implement corresponding procedures of the method 300 in FIG. 3. A specific process in which the units perform the foregoing corresponding steps is described in detail in the foregoing method embodiments, and for brevity, details are not described herein.

The communication apparatus 1100 corresponds to the remote UE in the method 400, the method 500, the method 600, the method 700, the method 900, or the method 1000 according to at least one embodiment. The communication apparatus 1100 includes units configured to perform the method performed by the remote UE in the method 400 in FIG. 4, the method 500 in FIG. 5, the method 600 in FIG. 6, the method 700 in FIG. 7, the method 900 in FIG. 9, or the method 1000 in FIG. 10. In addition, the units in the communication apparatus 1100 and the foregoing other operations and/or functions are separately used to implement corresponding procedures in the method 400 in FIG. 4, the method 500 in FIG. 5, the method 600 in FIG. 6, the method 700 in FIG. 7, the method 900 in FIG. 9, or the method 1000 in FIG. 10. A specific process in which the units perform the foregoing corresponding steps is described in detail in the foregoing method embodiments, and for brevity, details are not described herein.

The communication apparatus 1100 corresponds to the relay UE in the method 400, the method 500, the method 600, the method 700, the method 900, or the method 1000 according to at least one embodiment. The communication apparatus 1100 includes units configured to perform the method performed by the relay UE in the method 400 in FIG. 4, the method 500 in FIG. 5, the method 600 in FIG. 6, the method 700 in FIG. 7, the method 900 in FIG. 9, or the method 1000 in FIG. 10. In addition, the units in the communication apparatus 1100 and the foregoing other operations and/or functions are separately used to implement corresponding procedures in the method 400 in FIG. 4, the method 500 in FIG. 5, the method 600 in FIG. 6, the method 700 in FIG. 7, the method 900 in FIG. 9, or the method 1000 in FIG. 10. A specific process in which the units perform the foregoing corresponding steps is described in detail in the foregoing method embodiments, and for brevity, details are not described herein.

The communication apparatus 1100 corresponds to UE #1 in the method 800 according to at least one embodiment, and the communication apparatus 1100 includes units configured to perform the method performed by UE #1 in the method 800 in FIG. 8. In addition, units in the communication apparatus 1100 and the foregoing other operations and/or functions are separately used to implement corresponding procedures of the method 800 in FIG. 8. A specific process in which the units perform the foregoing corresponding steps is described in detail in the foregoing method embodiments, and for brevity, details are not described herein.

In response to the communication apparatus 1100 being a chip configured in a terminal device, the transceiver unit 1120 in the communication apparatus 1100 is implemented by using an input/output interface, and the processing unit 1110 in the communication apparatus 1100 is implemented by using the chip, a processor, a microprocessor, an integrated circuit, or the like that are integrated in a chip system.

In at least one embodiment, the communication apparatus 1100 corresponds to the policy control function network element in the foregoing method embodiments, for example, is a policy control function network element, or is a component (for example, a chip or a chip system) configured in the policy control function network element.

The communication apparatus 1100 corresponds to the policy control function network element in the method 800 according to at least one embodiment, and the communication apparatus 1100 includes units configured to perform the method performed by the policy control function network element in the method 800 in FIG. 8. In addition, units in the communication apparatus 1100 and the foregoing other operations and/or functions are separately used to implement corresponding procedures of the method 800 in FIG. 8. A specific process in which the units perform the foregoing corresponding steps is described in detail in the foregoing method embodiments, and for brevity, details are not described herein.

In response to the communication apparatus 1100 being a chip configured in a policy control function network element, the transceiver unit 1120 in the communication apparatus 1100 is implemented by using an input/output interface, and the processing unit 1120 in the communication apparatus 1100 is implemented by using the chip, a processor, a microprocessor, an integrated circuit, or the like that are integrated in a chip system.

In at least one embodiment, the communication apparatus 1100 corresponds to the access and mobility management function network element in the foregoing method embodiments, for example, is an access and mobility management function network element, or is a component (for example, a chip or a chip system) configured in the access and mobility management function network element.

The communication apparatus 1100 corresponds to the access and mobility management function network element in the method 800 according to at least one embodiment, and the communication apparatus 1100 includes units configured to perform the method performed by the access and mobility management function network element in the method 800 in FIG. 8. In addition, units in the communication apparatus 1100 and the foregoing other operations and/or functions are separately used to implement corresponding procedures of the method 800 in FIG. 8. A specific process in which the units perform the foregoing corresponding steps is described in detail in the foregoing method embodiments, and for brevity, details are not described herein.

In response to the communication apparatus 1100 being a chip configured in an access and mobility management function network element, the transceiver unit 1120 in the communication apparatus 1100 is implemented by using an input/output interface, and the processing unit 1110 in the communication apparatus 1100 is implemented by using the chip, a processor, a microprocessor, an integrated circuit, or the like that are integrated in a chip system.

FIG. 12 is a schematic block diagram of a wireless communications apparatus according to at least one embodiment. A communication apparatus 1200 shown in FIG. 12 includes a memory 1210, a processor 1220, and a communication interface 1230. The memory 1210, the processor 1220, and the communication interface 1230 are connected through an internal connection path. The memory 1210 is configured to store instructions. The processor 1220 is configured to execute the instructions stored in the memory 1210, to control an input/output interface to receive/send a packet. Optionally, the memory 1210 is coupled to the processor 1220 through an interface, or is integrated with the processor 1220.

The communication interface 1230 uses a transceiver apparatus, for example, but not limited to a transceiver, to implement communication between the communication apparatus 1200 and another device or a communication network. The communication interface 1230 further includes the input/output interface (input/output interface).

In an implementation process, the steps of the foregoing methods are completed by using a hardware integrated logic circuit in the processor 1220, or by using instructions in a form of software. The method of the communication disclosed with reference to at least one embodiment is directly performed by a hardware processor, or is performed by using a combination of hardware in the processor and a software module. The software module is located in a mature storage medium in the art, such as a random access memory, a flash memory, a read-only memory, a programmable read-only memory, an electrically erasable programmable memory, or a register. The storage medium is located in the memory 1210, and the processor 1220 reads information in the memory 1210 and completes the steps in the foregoing methods in combination with hardware of the processor 1220. To avoid repetition, details are not described herein again.

The processor in at least one embodiment is a central processing unit (central processing unit, CPU), or is another general-purpose processor, a digital signal processor (digital signal processor, DSP), an application-specific integrated circuit (application-specific integrated circuit, ASIC), a field programmable gate array (field programmable gate array, FPGA), or another programmable logic device, discrete gate or transistor logic device, discrete hardware component, or the like. The general-purpose processor is a microprocessor, or the processor is any conventional processor or the like.

In at least one embodiment, the memory includes a read-only memory and a random access memory, and provide instructions and data to the processor. A part of the processor further includes a non-volatile random access memory. For example, the processor further stores information of a device type.

FIG. 13 is a schematic diagram of a chip system according to at least one embodiment. The chip system herein is alternatively a system including a circuit. A chip system 1300 shown in FIG. 13 includes a logic circuit 1310 and an input/output interface (input/output interface) 1320. The logic circuit is configured to: be coupled to the input interface, and transmit data (for example, the first indication information) by using the input/output interface, to perform the methods described in FIG. 3 to FIG. 10.

At least one embodiment further provides a processing apparatus, including a processor and an interface. The processor is configured to perform the method in any one of the foregoing method embodiments.

The processing apparatus is one or more chips. For example, the processing apparatus is a field programmable gate array (field programmable gate array, FPGA), an application-specific integrated circuit (application-specific integrated circuit, ASIC), a system on chip (system on chip, SoC), a central processing unit (central processing unit, CPU), a network processor (network processor, NP), a digital signal processor (digital signal processor, DSP), a micro controller unit (micro controller unit, MCU), a programmable controller (programmable logic device, PLD), or another integrated chip.

According to the methods provided in at least one embodiment, this application further provides a computer program product. The computer program product includes computer program code. In response to the computer program code being run on a computer, the computer is enabled to perform the method performed by the terminal device, the policy control function network element, or the access and mobility management function network element in the embodiments shown in FIG. 3 to FIG. 10.

According to the methods provided in at least one embodiment, this application further provides a computer-readable storage medium. The computer-readable storage medium stores program code. In response to the program code being run on a computer, the computer is enabled to perform the method performed by the terminal device, the policy control function network element, or the access and mobility management function network element in the embodiments shown in FIG. 3 to FIG. 10.

According to the methods provided in at least one embodiment, this application further provides a system. The system includes one or more foregoing terminal devices, policy control function network elements, or access and mobility management function network elements.

The terminal devices in the foregoing apparatus embodiments correspond to the terminal devices in the method embodiments: the policy control function network elements in the foregoing apparatus embodiments correspond to the policy control function network elements in the method embodiments: and the access and mobility management function network elements in the foregoing apparatus embodiments correspond to the access and mobility management function network elements in the method embodiments. A corresponding module or unit performs a corresponding step. For example, a transceiver unit (a transceiver) performs a receiving step or a sending step in the method embodiments, and a step other than the sending step and the receiving step is performed by a processing unit (a processor). For a function of a specific unit, refer to a corresponding method embodiment. There is one or more processors.

Terms such as “component”, “module”, and “system” used in at least one embodiment are used to indicate computer-related entities, hardware, firmware, combinations of hardware and software, software, or software being executed. For example, a component is, but is not limited to, a process that runs on a processor, a processor, an object, an executable file, an execution thread, a program, and/or a computer. As shown in figures, both a computing device and an application that runs on a computing device is components. One or more components reside within a process and/or a thread of execution, and the components are located on one computer and/or distributed between two or more computers. In addition, these components are executed from various computer-readable media that store various data structures. For example, the components communicate by using a local and/or remote process and based on a signal having one or more data packets (for example, data from two components interacting with another component in a local system and/or a distributed system, and/or across a network such as the Internet interacting with other systems by using the signal).

A person of ordinary skill in the art is aware that, illustrative logical blocks (illustrative logical blocks) and steps (steps) described with reference to at least one embodiment is implemented by electronic hardware or a combination of computer software and electronic hardware. Whether functions are performed by hardware or software depends on particular applications and design constraints of the technical solutions. A person skilled in the art uses different methods to implement the described functions for each particular application, but the implementation is not considered to go beyond the scope of at least one embodiment.

A person skilled in the art that, for the purpose of convenient and brief description, for detailed working processes of the foregoing systems, apparatuses, and units, refer to corresponding processes in the foregoing method embodiments. Details are not described herein again.

In embodiments described herein, the disclosed system, apparatus, and method is implemented in other manners. For example, the described apparatus embodiment is merely an example. For example, division into the units is merely logical function division and is other division during actual implementation. For example, a plurality of units or components is combined or integrated into another system, or some features is ignored or not performed. In addition, the displayed or discussed mutual couplings or direct couplings or communication connections is implemented through some interfaces. The indirect couplings or communication connections between the apparatuses or units is implemented in electronic, mechanical, or other forms.

The units described as separate parts may or may not be physically separate, and parts displayed as units may or may not be physical units, that is, is located in one position, or is distributed on a plurality of network units. Some or all of the units is selected based on actual usage to achieve objectives of the solutions of the embodiments.

In addition, functional units in at least one embodiment are integrated into one processing unit, or each of the units exist alone physically, or two or more units are integrated into one unit.

In the foregoing embodiments, all or some of the functions of the function units are implemented by using software, hardware, firmware, or any combination thereof. In response to software being used to implement the embodiments, all or some of the embodiments are implemented in a form of a computer program product. The computer program product includes one or more computer instructions (programs). In response to the computer program instructions (programs) being loaded and executed on the computer, the procedure or functions according to at least one embodiment are all or partially generated.

In response to the functions being implemented in the form of a software functional unit and sold or used as an independent product, the functions are stored in a computer-readable storage medium. Based on such an understanding, a part of the technical solutions in at least one embodiment essentially contributing to the current technology, or some of the technical solutions are represented in a form of a software product. The computer software product is stored in a storage medium and includes several instructions for instructing a computer device (which is a personal computer, a server, a network device, or the like) to perform all or some of the steps of the method described in at least one embodiment. The foregoing storage medium includes any medium that stores program code, such as a USB flash drive, a removable hard disk, a read-only memory (read-only memory, ROM), a random access memory (random access memory, RAM), a magnetic disk, or an optical disc.

The foregoing descriptions are merely specific implementations of at least one embodiment, but are not intended to limit the protection scope of at least one embodiment. Any variation or replacement readily figured out by a person skilled in the art within the technical scope disclosed in at least one embodiment shall fall within the protection scope of at least one embodiment. Therefore, the protection scope of at least one embodiment shall be subject to the protection scope of the claims.

1. A communication method, comprising:
receiving, by a policy control function network element from an access and mobility management function network element, a request message for requesting a proximity-based service ProSe parameter of a first terminal device; and
sending, by the policy control function network element, the ProSe parameter to the first terminal device, wherein the ProSe parameter includes first information, the first information is for determining a manner of obtaining a first PC5 key, the first PC5 key is a key usable for a PC5 link between the first terminal device and a second terminal device, and the manner of obtaining the first PC5 key includes a control plane manner and/or a user plane manner.

2. The method according to claim 1, wherein the sending the ProSe parameter that includes the first information includes sending the first information usable to indicate to obtain a PC5 key in the control plane manner and/or the user plane manner.

3. The method according to claim 1, wherein the sending the ProSe parameter that includes the first information includes sending the first information including a mapping relationship between a first public land mobile network identifier of a home network of the first terminal device and second indication information or a mapping relationship between a second public land mobile network identifier of a home network of the second terminal device and second indication information, and the second indication information is usable to indicate to obtain a PC5 key in the control plane manner and the user plane manner.

4. The method according to claim 1, wherein the sending the ProSe parameter that includes the first information includes sending the first information including a mapping relationship between identifier information of a relay service corresponding to the PC5 link and second indication information, and the second indication information is usable to indicate to obtain a PC5 key in the control plane manner and the user plane manner.

5. The method according to claim 1, wherein the receiving the request message includes receiving the request message that includes the first information.

6. The method according to claim 1, wherein the method further comprises:
obtaining, by the policy control function network element, the first information from local configuration.

7. The method according to claim 6, wherein the method further comprises:
receiving, by the policy control function network element, the first information from an application function network element.

8. The method according to claim 1, wherein the method further comprises:
sending, by the policy control function network element to a first network element, a request message for requesting the first information; and
receiving, by the policy control function network element, the first information from the first network element.

9. A communication apparatus, comprising:
at least one memory storing a computer program or instructions; and
at least one processor, coupled to the at least one memory, wherein the at least one processor is configured to execute the computer program or instructions to perform operations to:
receive from an access and mobility management function network element, a request message for requesting a proximity-based service ProSe parameter of a first terminal device; and
send the ProSe parameter to the first terminal device, wherein the ProSe parameter includes first information, the first information is for determining a manner of obtaining a first PC5 key, the first PC5 key is a key usable for a PC5 link between the first terminal device and a second terminal device, and the manner of obtaining the first PC5 key includes a control plane manner and/or a user plane manner.

10. The communication apparatus according to claim 9, wherein the first information is usable to indicate to obtain a PC5 key in the control plane manner and/or the user plane manner.

11. The communication apparatus according to claim 9, wherein the first information includes a mapping relationship between a first public land mobile network identifier of a home network of the first terminal device and second indication information or a mapping relationship between a second public land mobile network identifier of a home network of the second terminal device and second indication information, and the second indication information is usable to indicated to obtain a PC5 key in the control plane manner and the user plane manner.

12. The communication apparatus according to claim 9, wherein the first information includes a mapping relationship between identifier information of a relay service corresponding to the PC5 link and second indication information, and the second indication information is usable to indicate to obtain a PC5 key in the control plane manner and the user plane manner.

13. The communication apparatus according to claim 9, wherein the first request message includes the first information.

14. The communication apparatus according to claim 9, wherein the at least one processor is further configured to:
obtain the first information from local configuration.

15. The communication apparatus according to claim 14, wherein the at least one processor is further configured to:
receive the first information from an application function network element.

16. The communication apparatus according to claim 9, wherein the at least one processor is further configured to:
send to a first network element, a request message for requesting the first information; and
receive the first information from the first network element.

17. A computer-readable storage medium, wherein the computer-readable storage medium stores a computer program which, when executed by at least one processor, causes the at least one processor to:
receive from an access and mobility management function network element, a request message for requesting a proximity-based service ProSe parameter of a first terminal device; and
send the ProSe parameter to the first terminal device, wherein the ProSe parameter includes first information, the first information is for determining a manner of obtaining a first PC5 key, the first PC5 key is a key usable for a PC5 link between the first terminal device and a second terminal device, and the manner of obtaining the first PC5 key includes a control plane manner and/or a user plane manner.
